(19) United States
(12) Patent Application Publication
(10) Pub. No.: US 2026/0331718 A1
(43) Pub. Date: Oct. 22, 2026

(54) Battery Cell, Battery Pack and Vehicle Including Same

(71) Applicant: LG Energy Solution, Ltd., Seoul (KR)

(72) Inventors: Jun-Ho Baek, Daejeon (KR); Sung-Min Cho, Daejeon (KR)

(21) Appl. No.: 19/655,217

(22) Filed: Apr. 22, 2026

(30) Foreign Application Priority Data
Apr. 22, 2025 (KR) 10-2025-0052606
Dec. 24, 2025 (KR) 10-2025-0210034
Mar. 12, 2026 (KR) 10-2026-0044926

(51) Int. Cl. H01M 50/533; H01M 10/04; H01M 10/48; H01M 10/613; H01M 50/107; H01M 50/152; H01M 50/213; H01M 50/249; H01M 50/342; H01M 50/538; H01M 50/627

(52) U.S. Cl. CPC H01M 50/533; H01M 10/0422; H01M 10/488; H01M 10/613; H01M 50/107; H01M 50/152; H01M 50/213; H01M 50/249; H01M 50/3425; H01M 50/538; H01M 50/627; H01M 2220/20

(57) ABSTRACT

A battery cell includes a wound electrode assembly accommodated in a cell housing and having a can lid covering an opening at an open end of the cell housing. The can lid includes multiple electrode-coupling portions spaced apart circumferentially about a center of the can lid. The electrode-coupling portions are recessed into the can lid so as to electrically contact an electrode of the electrode assembly. Multiple radially oriented bridges and separated portions are spaced apart circumferentially about the can lid to partition the electrode-coupling portions from one another.

### CROSS-REFERENCE TO RELATED APPLICATIONS

This application claims priority from Korean Patent Application No. 10-2025-0052606 filed Apr. 22, 2025, Korean Patent Application No. 10-2025-0210034 filed Dec. 24, 2025, and Korean Patent Application No. 10-2026-0044926 filed Mar. 12, 2026, the entire disclosures of which are incorporated herein by reference.

### TECHNICAL FIELD

The present disclosure relates to a battery cell, and a battery pack and a vehicle including the same, and, more specifically, to a battery cell with improved heat dissipation performance, as well as a battery pack and a vehicle including the same.

### BACKGROUND

Recently, the demand for portable electronic products such as laptop PCs, video cameras, and mobile phones has rapidly increased, and the development of electric vehicles, energy storage batteries, robots, satellites, and other related technologies has accelerated. As a result, active research on high-performance secondary batteries, which can be repeatedly charged and discharged, is underway.

Currently commercialized secondary batteries include nickel-cadmium batteries, nickel-hydrogen batteries, nickel-zinc batteries, and lithium-ion secondary batteries. Among these, lithium-ion secondary batteries are in the spotlight for their advantages of flexible charging and discharging due to almost no memory effect, a very low self-discharge rate, and a high energy density, compared to nickel-based secondary batteries.

These lithium-ion secondary batteries generally use lithium-based oxides and carbon materials as positive and negative electrode active materials, respectively. In addition, the lithium-ion secondary batteries include an electrode assembly in which the positive and negative electrode plates coated with the positive and negative electrode active materials, respectively, are disposed with a separator therebetween, and the electrode assembly is sealed within an exterior case along with an electrolyte.

Lithium-ion secondary batteries may be classified, depending on the shape of a battery case, into pouch-type secondary batteries, in which the electrode assembly is accommodated in a pouch of an aluminum laminate sheet, and can-type secondary batteries, in which the electrode assembly is accommodated in a metal can. In addition, can-type secondary batteries may be further classified into cylindrical batteries and prismatic batteries depending on the shape of the metal can. Lithium-ion secondary batteries can be used in battery modules or battery packs by overlapping or stacking multiple battery cells on each other into a dense structure, so as to provide high voltage and high current, and then electrically connecting the multiple cells.

A battery cell may include an electrode assembly in which electrodes are wound with a separator interposed therebetween and accommodated in a cell housing. Some battery cells may have a beading portion and a crimping portion. The beading portion is defined by forming a recessed shape along the side of the cell housing proximate the opening in order to fix the electrode assembly within the cell housing and adjust the form factor of the battery cell. The crimping portion is a portion of the cell housing along the opening that is bent and extended in order to seal the opening.

Recently, in order to improve space efficiency and energy density and increase productivity, battery cells (hereinafter referred to as conventional battery cells) that do not have parts such as the above-mentioned beading portion and crimping portion have been developed. Such conventional battery cells may include components such as a can lid that are coupled to the end of the opening of the cell housing.

Among the methods of cooling battery cells incorporated in battery modules or battery packs, there may be a so-called “bottom cooling method” that cools the bottoms of the battery cells. Nevertheless, further development of battery cells so as to improve the effectiveness of bottom cooling may be desirable.

### SUMMARY

### Technical Problem

The present disclosure may, among other things, solve problems in the related art. For example, the present disclosure may provide a battery cell with improved heat dissipation performance, as well as a battery pack and a vehicle including the same.

The present disclosure may also provide a battery cell that allows for more effective bottom cooling, as well as a battery pack and a vehicle including the same.

The technical problems that the present disclosure seeks to solve are not limited to the above-mentioned problems, and other problems not mentioned above will be clearly understood by those skilled in the art from the detailed disclosure described below.

### Technical Solution

In one aspect of the present disclosure, there is provided a battery cell. The battery cell according to such aspect of the disclosure includes: an electrode assembly, a cell housing, and a can lid. The electrode assembly includes a plurality of electrodes having a separator interposed between them and wound around a central axis. The cell housing has an open end and a closed end that oppose one another along an axial direction parallel to the central axis, where the open end defines an opening into an interior space within the cell housing, and the interior space accommodates the electrode assembly therein. The can lid is coupled to the open end of the cell housing so as to cover the opening. The can lid has a plurality of electrode-coupling portions electrically connected to one of the electrodes in the electrode assembly. An area defined by such plurality of electrode-coupling portions in a transverse plane that extends orthogonally to the central axis desirably occupies from 25% to 50% of a total area of the can lid within that transverse plane.

Each of the electrode-coupling portions may be shaped such that a width of the respective electrode-coupling portion increases at progressively larger distances from the central axis along a radial direction, where the width of the respective electrode-coupling is defined along a direction perpendicular to the radial direction.

The plurality of the electrode-coupling portions may be arranged rotationally-symmetrically about the central axis.

The can lid may further include an injection port positioned along the central axis and configured to open into the interior space of the cell housing.

A radial length from a center of the can lid to a radial outer end of the flat portion may be 4 mm to 10 mm.

The flat portion may have a mounting portion on which a portion of a plug inserted into the injection port is mounted.

A radial length of the flat portion, excluding the mounting portion, may be 2 mm to 4 mm.

The flat portion may surround the injection port. The flat portion may be spaced further from the electrode assembly along the axial direction than the electrode-coupling portions. A common boundary defined between the flat portion and at least one of the electrode-coupling portions may be recessed towards the central axis.

At least a portion of an outer surface of the flat portion may be recessed toward the electrode assembly.

The can lid may further include an edge portion that is press-fit into the opening at the open end of the cell housing.

The edge portion may have an outer wall that is coupled to an inner circumference of the cell housing, and the edge portion may have a convex portion that has a convex shape oriented toward the electrode assembly. A cross section of an outer edge of the edge portion farthest from the electrode assembly may have a right angle shape.

The can lid may include at least one separated portion extending radially inwardly towards the central axis along a radial direction from a region along an outer perimeter of the can lid so as to at least partially partition two neighboring electrode-coupling portions in a circumferential direction about the central axis. The separated portion may be axially spaced further from the electrode assembly along the axial direction than the electrode-coupling portions.

The separated portion may be axially spaced further from the electrode assembly than the electrode-coupling portions by a distance in a range from 0.6 mm to 1.3 mm.

A width of the separated portion in the circumferential direction may be in a range from 3 mm to 20 mm. A width of the separated portion in the circumferential direction may be in a range from 6.59% to 44.0% of a length of a diameter of the can lid.

The can lid may include at least one bridge elongated along the radial direction and extending radially inwardly towards the central axis from the separated portion so as to at least partially partition the two neighboring electrode-coupling portions in the circumferential direction. The bridge may be axially spaced further from the electrode assembly than the electrode-coupling portions.

A width of the bridge in a direction perpendicular to the radial direction may be in a range from 2 mm to 10 mm. A width of the bridge in a direction perpendicular to the radial direction may be in a range from 4.40% to 22.0% of a length of a diameter of the can lid.

The bridge may be axially spaced further from the electrode assembly than the electrode-coupling portions, and the separated portion may be axially spaced further from the electrode assembly than the bridge.

The bridge may be axially spaced further from the electrode assembly than the electrode-coupling portions by a distance in a range from 0.3 mm to 1.0 mm.

The separated portion may be axially spaced further from the electrode assembly than the bridge by a distance in a range from 0.2 mm to 0.3 mm.

The can lid may include an indicator portion that displays product information about the battery cell. The indicator portion may be positioned on a region of the can lid other than along the electrode-coupling portions.

The can lid may include: a wall portion and a first round portion. The wall portion may extend along the axial direction away from the electrode assembly from at least a part of an edge of a first one of the plurality of electrode-coupling portions. The first round portion may be defined along an outer boundary of the can lid at a junction between the wall portion and the first electrode-coupling portion, the first round portion having a rounded shape. A radius of curvature of the first round portion may be in a range of 0.05 mm to 0.30 mm.

The can lid may include: a first wall portion, a second wall portion, and a second round portion. The first wall portion may extend along the axial direction away from the electrode assembly from a radially outer edge of a first one of the plurality of electrode-coupling portions. The second wall portion may extend along the axial direction away from the electrode assembly from an edge of the first electrode-coupling portion that is oriented along a radial direction towards the central axis. The second round portion may be defined along an outer boundary of the can lid adjoining the first electrode-coupling portion, the second round portion extending along a curved path between the first wall portion and the second wall portion. A radius of curvature of the curved path of the second round portion at an axial position of the first electrode-coupling portion may be in a range of 1.0 mm to 5.0 mm.

The radius of curvature of the curved path of the second round portion may increase as an axial distance from the electrode assembly increases.

The can lid may not include a venting structure configured to rupture under internal gas pressure within the interior space of the cell housing so as to vent gas from the interior space.

The closed end of the cell housing may have a venting structure in the form of a notch formed along at least a portion of a surface of the closed end.

Each of the electrode-coupling portions may have a curved edge defining a boundary of the respective electrode-coupling portion furthest from the central axis. Each such curved edge may have a center of curvature positioned along a respective radial direction between the central axis and the respective curved edge.

In another aspect of the present disclosure, there is provided a battery pack including at least one battery cell according to the present disclosure.

In another aspect of the present disclosure, there is provided a vehicle including at least one battery pack according to the present disclosure.

### Advantageous Effects

Some aspects of the present disclosure provide a battery cell with improved heat dissipation performance, as well as a battery pack and a vehicle including the same.

Some aspects of the present disclosure provide a battery cell (as well as a battery pack and a vehicle including the same) in which good abutting surface contact between a can lid and an electrode assembly may be easily achieved.

Some aspects of the present disclosure provide a battery cell having improved adhesion and weldability between a can lid and an electrode assembly, as well as a battery pack and a vehicle including the same.

Some aspects of the present disclosure provide a battery cell with improved electrical stability, as well as a battery pack and a vehicle including the same.

Some aspects of the present disclosure provide a battery cell with reduced electrical resistance, as well as a battery pack and a vehicle including the same.

Some aspects of the present disclosure provide a battery cell with improved area efficiency, as well as a battery pack and a vehicle including the same.

Some aspects of the present disclosure provide a battery cell including a can lid with improved rigidity, as well as a battery pack and a vehicle including the same.

Some aspects of the present disclosure provide a battery cell having improved bottom cooling performance, as well as a battery pack and a vehicle including the same.

Some aspects of the present disclosure provide a battery cell with improved expansion performance, as well as a battery pack and a vehicle including the same.

Some aspects of the present disclosure provide a battery cell in which a gap between the can lid and the cell housing is reduced, as well as a battery pack and a vehicle including the same.

Some aspects of the present disclosure provide a battery cell that is more easily fabricated, as well as a battery pack and a vehicle including the same.

The effects obtainable from the present disclosure are not limited to the above-mentioned effects, and other effects not mentioned above will be clearly understood by those skilled in the art from the detailed disclosure described below.

### DESCRIPTION OF DRAWINGS

The accompanying drawings illustrate preferred aspects of the present disclosure that, together with this disclosure, serve to provide further understanding of the technical features of the present disclosure. However, it is to be understood that the present disclosure is not to be construed as being limited to the details illustrated in the drawings.

FIG. 1 is a top perspective view of a battery cell according to an aspect of the present disclosure.

FIG. 2 is a bottom perspective view of the battery cell of FIG. 1.

FIG. 3 is a side cross-sectional view showing the interior of a battery cell according to an aspect of the present disclosure.

FIG. 4 is a perspective view showing a can lid according to an aspect of the present disclosure.

FIG. 5 is a plan view showing a can lid according to an aspect of the present disclosure.

FIG. 6 is an enlarged side cross-sectional view showing a portion of the can lid of FIG. 3.

FIG. 7 is an enlarged side cross-sectional view showing another portion of the can lid of FIG. 3.

FIG. 8 is an enlarged side cross-sectional view showing the closed portion of the cell housing of FIG. 3.

FIG. 9 is an exaggerated enlarged side cross-sectional view representing an expanded state of the can lid.

FIG. 10 is an exaggerated enlarged side cross-sectional view representing a state where a gap occurs between the can lid and the cell housing.

Parts (a)-(c) of FIG. 11 are partial plan views of different can lids according to the present disclosure.

Parts (a)-(d) of FIG. 12 are plan views of different can lids according to the present disclosure.

FIG. 13 is an enlarged side cross-sectional view showing an edge portion of a can lid according to another aspect of the present disclosure.

Parts (a)-(d) of FIG. 14 are partial plan views of different can lids according to other aspects of the present disclosure.

FIG. 15 is a partially cut-away perspective view of a battery pack according to an aspect of the present disclosure.

FIG. 16 is a side cross-sectional view of a battery pack according to an aspect of the present disclosure.

FIG. 17 is a perspective diagrammatic illustration of a vehicle including the battery pack of FIG. 15 according to an aspect of the present disclosure.

### DETAILED DESCRIPTION

Hereinafter, preferred aspects of the present disclosure will be described in detail with reference to the accompanying drawings. Prior to the description, it should be understood that the terms used in the specification and the appended claims should not be construed as limited to general and dictionary meanings, but rather interpreted based on the meanings and concepts corresponding to technical aspects of the present disclosure. Therefore, the description presented herein just relates to preferred examples for the purpose of illustration only, and does not represent the entire scope of the disclosure, so it should be understood that other equivalents and modifications could be made thereto without departing from the scope of the disclosure.

In addition, for purposes of better understanding the present disclosure, the accompanying drawings are not necessarily drawn to scale, and the dimensions of certain elements may be exaggerated for clarity. In addition, the same reference numerals may indicate the same or similar elements across different aspects.

Stating that two elements are the same indicates that they are “substantially the same.” Therefore, the term “substantially the same” may encompass variations that are considered minor in the art, such as a deviation of less than about 5%. In addition, a parameter described as being uniform in a certain area may be understood to mean that it is uniform on average, rather than being strictly uniform at every point.

Although “first,” “second,” etc. are used to describe various elements, such elements are not limited to those terms. Rather, those terms are only used to distinguish one element from another element, and, unless otherwise stated, a first element may also be a second element, and so on.

Throughout the specification, unless otherwise stated, each element may include a single or a plurality of elements.

Discussions and illustrations of an element being disposed “in the upper portion (or lower portion)” or “at the top (or bottom)” of a target element may indicate that the element is disposed in contact with the upper surface (or lower surface) of the target element or that another element may be interposed between the target element and the element disposed at the top (or bottom) of the target element.

Additionally, the expression “an element is ‘connected,’ ‘coupled,’ or ‘joined to another element” should be understood as meaning that the two elements may be directly connected or joined to each other, or that another element may be “interposed” between the two elements, or that the two elements may be “connected,” “coupled,” or “joined” via another element.

Throughout the specification, unless otherwise stated, the expression “A and/or B” may refer to A, B, or both A and B, and the expression “C to D” may refer to a range including values equal to or greater than C and equal to or less than D.

Meanwhile, the descriptions of any feature in one aspect of the present disclosure that is common to another aspect may also be applied to that common feature in the other aspect. For example, any content in the second aspect that is common to the first aspect may be replaced with the description of that content in the first aspect, and such common content is also applicable to the second aspect. Likewise, any feature described in the second aspect that can be applied to the first aspect may also be applied to the first aspect. The same applies to other aspects as well.

In the present specification, unless otherwise stated, the X-and Y-axis directions may correspond to the left-right and front-back directions, or to the front-back and left-right directions, respectively, and the Z-axis direction, which is perpendicular to the X-Y plane, may correspond to the up-down direction (vertical direction).

In the present specification, for convenience of description, a direction along the longitudinal axis of the central axis of the winding center core of the electrode assembly will be referred to as an axial direction. The axial direction may be the Z-axis direction. A direction surrounding the central axis of the winding center core will referred to as a circumferential direction. In addition, a direction approaching or receding from the central axis of the winding center core will be referred to as a radial direction.

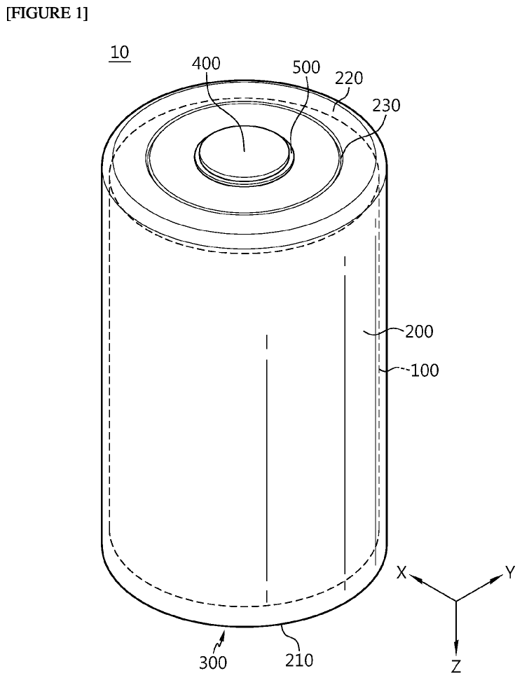

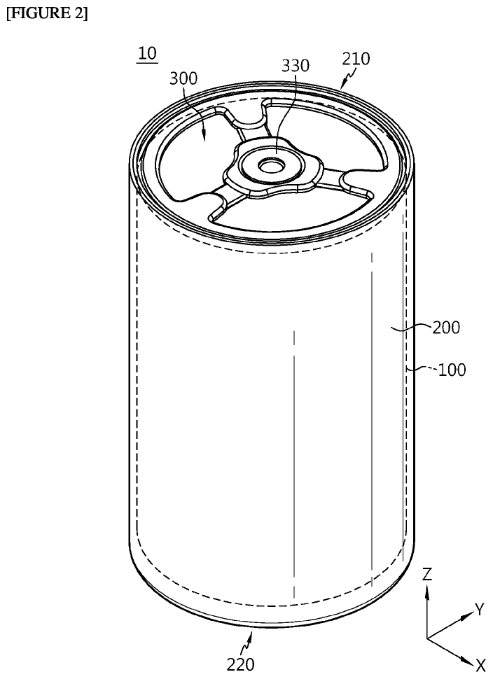

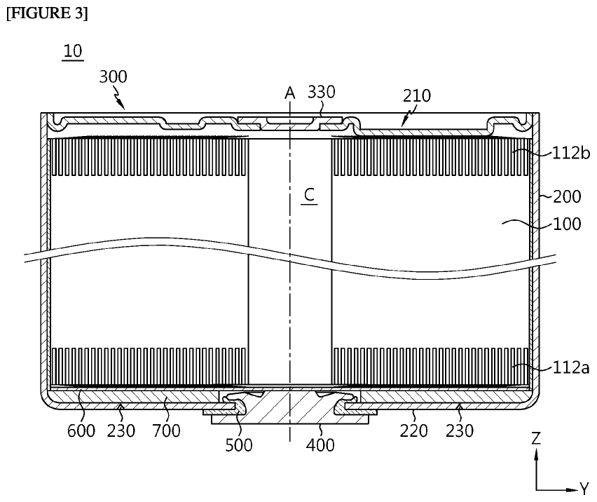

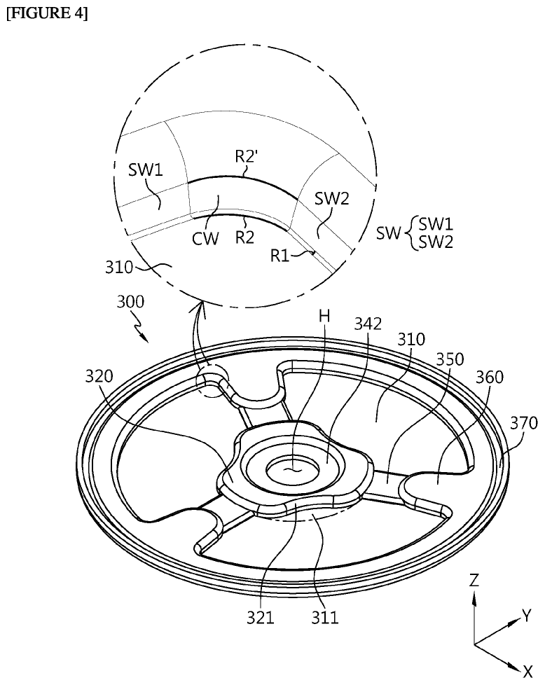

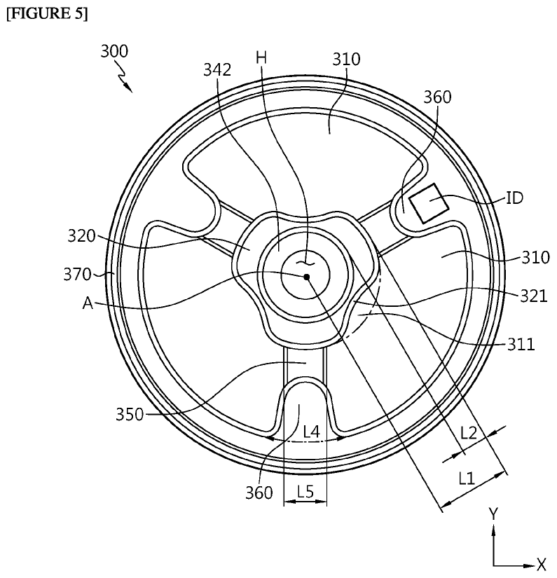

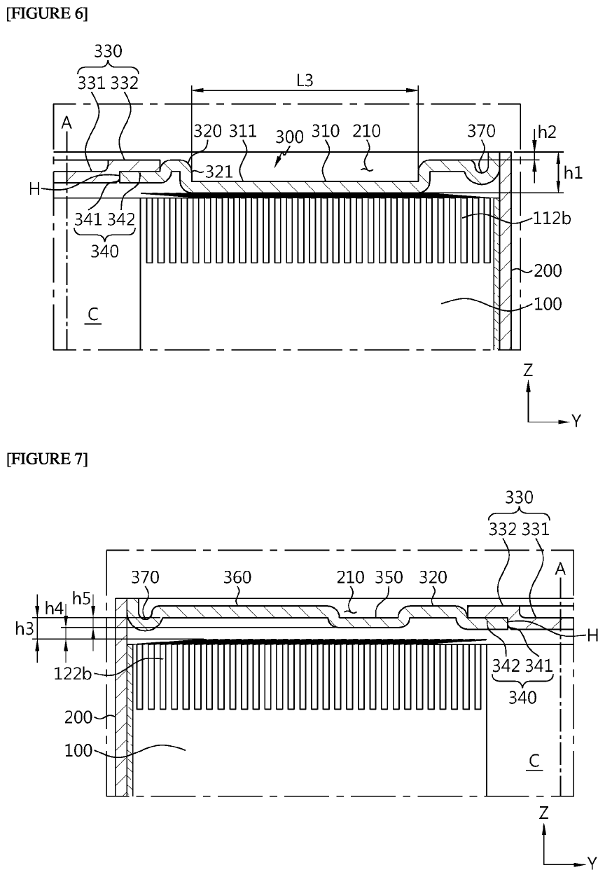

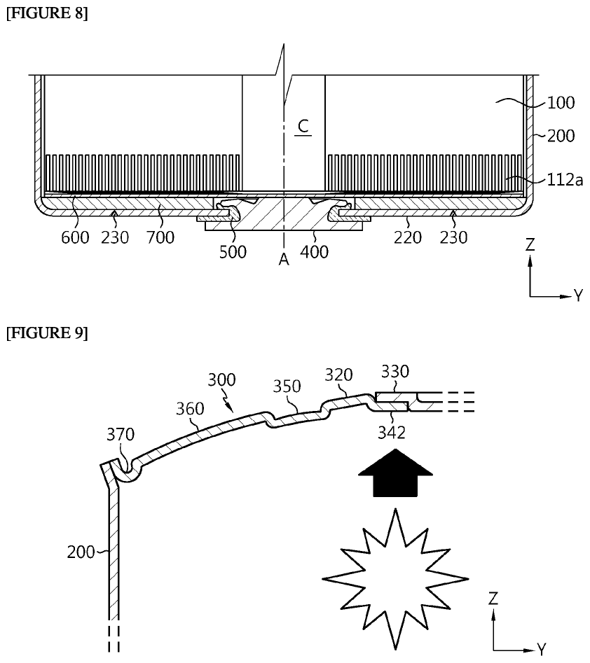

FIG. 1 is a top perspective view showing the overall configuration of a battery cell according to an aspect of the present disclosure, FIG. 2 is a bottom perspective view of the battery cell of FIG. 1, FIG. 3 is a side cross-sectional view showing the interior of a battery cell according to an aspect of the present disclosure, FIG. 4 is a perspective view showing a can lid according to an aspect of the present disclosure, FIG. 5 is a plan view showing a can lid according to an aspect of the present disclosure, FIG. 6 is an enlarged side cross-sectional view showing a portion of the can lid of FIG. 3, and FIG. 7 is an enlarged side cross-sectional view showing another portion of the can lid of FIG. 3.

Referring to FIGS. 1 to 3, a battery cell 10 according to an aspect of the present disclosure may include an electrode assembly 100, a cell housing 200, and a can lid 300.

The battery cell 10 may be a secondary battery configured to be chargeable and dischargeable. For example, the battery cell 10 may be a cylindrical battery cell 10.

The electrode assembly 100 may include a first electrode, a second electrode, and a separator interposed therebetween. The first electrode may have a first polarity, and the second electrode may have a second polarity opposite to the first polarity. For example, the first polarity may be a positive polarity, and the second polarity may be a negative polarity. In the following description, the first electrode may be referred to as a positive electrode, and the second electrode may be referred to as a negative electrode. However, it should be understood that the polarities of the first electrode and the second electrode described in the aspects may be changed or reversed.

The electrode assembly 100 may be configured by stacking a first electrode and a second electrode with a separator interposed therebetween to form a stack. The electrode assembly 100 may be configured in the form of a jelly-roll by winding a stack of the first electrode, the second electrode, and the separator of the electrode assembly 100 around a central axis A of a winding center core C. The winding center core C may be defined by a region positioned radially inwardly of the radially innermost portions of the first and second electrodes wound into the jelly-roll. The winding center core C may be substantially or entirely free of solid structures, or solid components may be positioned in the winding center core C. For example, additional separator material may be positioned in the winding center core C. In that regard, the separator wound with the first and second electrodes may continue radially inwardly from the radially innermost portions of the first and second electrodes (e.g., by continuing to be wound spirally or by being bunched up), and such separator material may partially or fully fill the winding center. Alternatively or additionally, a central pin may be positioned in the winding center core C along the central axis A. As an example, a pin or mandrel about which the separator and the first and second electrodes are wound may remain in the winding center core C and serve as the central pin, or a different central pin may replace the mandrel used for winding the separator, or the winding center core C may remain largely hollow by simply removing the mandrel after winding and not replacing it with another solid component. The electrodes (first and second electrodes) may include an uncoated portion that does not include an active material. The uncoated portion may be provided along the long-side edge of each electrode before winding, and may be positioned at the axial end of the electrode assembly 100 after winding. The uncoated portion may include a plurality of foil tabs. The plurality of foil tabs may be formed in the uncoated portion by notching or slitting. in an alternative, the foil tab may be configured as a full-tab structure in which the uncoated portion has a continuous shape without being notched or slit.

For example, the first electrode may be a positive electrode plate, and a positive electrode active material may be applied to one or both sides of the positive electrode plate. A first uncoated portion 112a where the positive electrode active material is not applied may be formed at an end of the positive electrode plate. The first uncoated portion 112a may be formed at one side of the positive electrode plate extending parallel to the winding direction of the stack. The first uncoated portion 112a may be exposed to the outside by protruding beyond the edge of the separator in the axial direction while forming a plurality of winding turns around the central axis A of the winding center core C, and may serve as the electrode tab itself.

The second electrode is a negative electrode plate, and a negative electrode active material may be applied to one or both surfaces of the negative electrode plate. A second uncoated portion 112b where the negative electrode active material is not applied may be formed at an end of the negative electrode plate. The second uncoated portion 112b may be formed at one side of the negative electrode plate extending parallel to the winding direction of the laminate. The second uncoated portion 112b may be exposed to the outside by protruding from the edge of the separator in the axial direction while forming a plurality of winding turns around the central axis A of the winding center core C, and may serve as the electrode tab itself.

The edge of the separator from which the second uncoated portion 112b protrudes in the axial direction may be axially opposite to the edge of the separator from which the first uncoated portion 112a protrudes in the axial direction. Accordingly, electrode tabs of opposite polarities may be positioned at opposite ends of the wound electrode assembly 100 along the axial direction. For example, the first uncoated portion 112a may be positioned at the −Z-direction end of the electrode assembly 100, and the second uncoated portion 112b may be positioned at the +Z-direction end of the electrode assembly 100.

That is, the positive electrode plate and the negative electrode plate may each include an uncoated portion, on which the active material is not coated, at the long-side end in the winding direction. In addition, the first uncoated portion 112a and the second uncoated portion 112b may be configured to protrude in opposite axial directions.

The first uncoated portion 112a and the second uncoated portion 112b may each include, for example, a plurality of foil tabs each having a trapezoidal shape and arranged along the winding direction. The plurality of foil tabs may be formed by notching or slitting the uncoated portion. In a jellyroll-shaped electrode assembly 100, the foil tabs may be bent in the radial direction so as to be flattened in an overlapping arrangement. The foil tabs may be bent inward or outward in the radial direction. The foil tabs may be individually bent during the process of winding the laminate to form the jellyroll-shaped electrode assembly 100. Alternatively, the foil tabs may be bent all at once after the laminate is wound to form the jellyroll-shaped electrode assembly 100. The foil tabs of the first uncoated portion 112a and the foil tabs of the second uncoated portion 112b, which are radially bent to overlap each other as described above, may form planes substantially perpendicular to the axial direction at both axial ends of the electrode assembly 100.

The electrode assembly 100 may be accommodated in an interior space of the cell housing 200. The cell housing 200 may be, for example, cylindrical. When the cell housing 200 is cylindrical, the battery cell 10 may be configured as a cylindrical battery cell 10.

An opening 210 may be provided at one side of the cell housing 200. For example, the opening 210 may be positioned on the +Z-direction side of the cell housing 200. The electrode assembly 100 may be inserted into the cell housing 200 through the opening 210 formed at one side of the cell housing 200 and accommodated in the cell housing 200.

A can lid 300 may be coupled to one end of the cell housing 200 and the electrode assembly 100. Specifically, the can lid 300 may be coupled to one end of the cell housing 200 where the opening 210 is formed.

The can lid 300 may be configured to cover the opening 210. The can lid 300 may be configured to seal the opening 210 of the cell housing 200. The can lid 300 may be force-fitted to one end of the cell housing 200. The can lid 300 may be welded to one end of the cell housing 200. That is, the can lid 300 may be arranged at one end of the cell housing 200 in which the opening 210 is formed, and then the can lid 300 and the cell housing 200 may be welded together.

The can lid 300 may be configured in a roughly circular shape to cover the opening 210.

The can lid 300 may be electrically connected to the cell housing 200.

The can lid 300 may be coupled to the electrode assembly 100. The can lid 300 may be electrically connected to the electrode assembly 100.

The can lid 300 may be electrically connected to both the cell housing 200 and the electrode assembly 100. In such case, the cell housing 200 may have the second polarity.

Hereinafter, the battery cell 10 according to an aspect of the present disclosure will be described in detail with reference to FIGS. 3 to 7.

The can lid 300 may include an electrode-coupling portion 310. The electrode-coupling portion 310 may be coupled to the electrode assembly 100. For example, the electrode-coupling portion 310 may be coupled to the second electrode. The electrode-coupling portion 310 may be coupled to the electrode assembly 100 by welding. For example, the electrode-coupling portion 310 may contact and be welded to the second uncoated portion 112b.

The lower surface (the surface facing the electrode assembly 100) of the electrode-coupling portion 310 may be electrically coupled to the electrode assembly 100 by surface-to-surface contact. More particularly, the lower surface of the electrode-coupling portion 310 may be coupled to the second uncoated portion 112b.

The electrode-coupling portion 310 may be disposed relatively closer to the electrode assembly 100 than the peripheral portion. Here, the “peripheral portion” may be understood as a portion of the can lid 300 located radially outwardly from the electrode-coupling portion 310, and the peripheral portion may extend circumferentially around the electrode-coupling portion 310. The electrode-coupling portion 310 may be disposed lower or further in the −Z direction than the peripheral portion such that it is disposed closer to the electrode assembly 100 than the peripheral portion.

The electrode-coupling portion 310 may be formed so as to be recessed toward the electrode assembly 100 in the axial direction relative to immediately adjacent portions of the can lid 300. For example, the electrode-coupling portion 310 may be recessed toward the −Z direction.

The can lid 300 may include a plurality of electrode-coupling portions 310. The electrode-coupling portions 310 may be spaced apart from each other. For example, the electrode-coupling portions 310 may be spaced apart from each other along the circumferential direction. For example, three electrode-coupling portions 310 may be provided. However, the number of electrode-coupling portions 310 is not limited thereto, and two or four electrode-coupling portions 310 may also be provided.

If a plurality of the electrode-coupling portions 310 is provided, good abutting surface contact (which may also be referred to as “flatness”) between the can lid 300 and the electrode assembly 100 may be stably and easily achieved. Good abutting surface contact (or flatness) may be defined by a state of extensive close contact between abutting surfaces of the electrode assembly 100 and the can lid 300 over many different portions of the can lid 300, such that the surfaces of the can lid 300 that contact the electrode assembly 100 (i.e., the lower surfaces of the electrode-coupling portions 310) abut and extend in an essentially coplanar relationship with the plane defined by the radially bent foil tabs of the second uncoated portion 112b. If good abutting surface contact between the can lid 300 and the electrode assembly 100 is achieved, good adhesion and weldability between the can lid 300 and the electrode assembly 100 may also be easily achieved, such that the electrical stability of the battery cell 10 may also be improved.

The electrode-coupling portion 310 may be formed in a fan shape. Specifically, when viewed in a direction along the central axis A of the winding center core C, the electrode-coupling portion 310 may be formed in a fan shape. Here, the fan shape may be understood as a portion of an annular or ring shape having a predetermined width in the radial direction between the inner and outer circumferences. For example, the electrode-coupling portion 310 may be configured in a form that occupies a portion of an annular or ring shape having a predetermined width in the radial direction between the flat portion 320, explained later, and the edge portion 370, explained later.

If the electrode-coupling portion 310 is formed in a fan shape as above, the can lid 300 having a roughly circular shape may be configured so that the contact area with the electrode assembly 100 may be maximized. For example, if the can lid 300 is configured in a circular shape having a diameter of about 45 mm to 46 mm, the total contact area between all of the electrode-coupling portions 310 of the can lid 300 and the electrode assembly 100 may be about 701 mm².

If the contact area between the electrode-coupling portion 310 and the electrode assembly 100 increases, the heat dissipation performance of the can lid 300 may be improved. Here, the heat dissipation performance of the can lid 300 may refer to the performance of dissipating heat originating from the electrode assembly 100 and transferred to the outside. In addition, if the contact area between the electrode-coupling portions 310 and the electrode assembly 100 increases, the welding area between the can lid 300 and the electrode assembly 100 may also increase, and thus the cross-sectional area for passing current between the can lid 300 and the electrode assembly 100 may be improved.

Therefore, if the electrode-coupling portion 310 is formed in a fan shape, the heat dissipation performance of the can lid 300 may be maximized. In addition, the electrical coupling and resulting current path between the can lid 300 and the electrode assembly 100 may also be maximized.

Since the can lid 300 according to the present disclosure is coupled to the cell housing 200 to cover the opening 210 of the cell housing 200 while being directly electrically coupled to the electrode assembly 100, a separate component, such as a negative electrode current collector, need not be provided. That is, the can lid 300 according to the present disclosure may be provided as a so-called integrated can lid 300 that may also function as a current collector.

A closed portion 220 may be provided at the other side of the cell housing 200. For example, the closed portion 220 may be provided on the −Z-direction side of the cell housing 200. In the cell housing 200, the closed portion 220 may be located at the axially opposite end of the cell housing 200 from the opening 210.

The cell housing 200 may contain a conductive metal. For example, the cell housing 200 may contain a nickel-plated steel (NPS) material, but the material of the cell housing 200 is not limited thereto.

The battery cell 10 according to the present disclosure may further include an electrode terminal 400. The electrode terminal 400 may be disposed on the closed portion 220. The electrode terminal 400 may be electrically coupled to the first electrode. The electrode terminal 400 may have the first polarity. The electrode terminal 400 may be configured in the form of a rivet that passes through the closed portion 220.

The cell housing 200, excluding the electrode terminal 400, may be electrically coupled to the second electrode and may have the second polarity. The closed portion 220 may also have the second polarity. That is, the battery cell 10 according to the present disclosure may have both the first and second polarities formed on the closed portion 220. Specifically, the electrode terminal 400 may be configured as a terminal of the first polarity, and the remaining part of the closed portion 220 excluding the electrode terminal 400 may be configured as a terminal of the second polarity. An insulating gasket 500 may be positioned between the closed portion 220 and the electrode terminal 400 to electrically insulate them.

The battery cell 10 according to the present disclosure may include a current collector 600. The current collector may have the first polarity. The current collector 600 may be configured as, for example, a positive electrode current collector. The current collector 600 may be electrically connected to the first uncoated portion 112a. The current collector 600 may be disposed between the electrode assembly 100 and the closed portion 220 within the cell housing 200. An insulator 700 may be disposed between the current collector 600 and the closed portion 220. The insulator 700 may be configured to electrically insulate the current collector 600 and the closed portion 220 from each other.

The cell housing 200 may be elongated along the axial direction, parallel to the central axis A. For example, the cell housing 200 may have a side wall portion extending along (and parallel to) the axial direction, the opening 210 may be formed at one axial end of the side wall portion, and the closed portion 220 having a bottom portion may be formed at the other axial end of the side wall portion. The cell housing 200 may be configured not to have a portion that is recessed or bent inwardly in the radial direction. For example, the cell housing 200 may not include a beading portion(which is a portion recessed inwardly in the radial direction) and/or a crimping portion (which is a portion bent inwardly in the radial direction). When the cell housing 200 is configured in this manner, the inner space of the battery cell 10 may be maximized, thereby improving the space efficiency and energy density of the battery cell 10.

The total height (h1) of the can lid 300 may be 1.0 mm to 3.0 mm. The total height (h1) of the can lid 300 may be understood as the height in the axial direction or the Z-axis direction. If the total height (h1) of the can lid 300 is less than 1.0 mm, the peripheral portion of the electrode-coupling portion 310 may not be reliably separated from the electrode assembly 100. If the total height (h1) of the can lid 300 exceeds 3.0 mm, the volume occupied by the can lid 300 may be unnecessarily too large, which may lower the energy density of the battery cell 10.

The electrode-coupling portion 310 may be configured so that, when viewed along the axial direction, the width of the electrode-coupling portion 310 in a direction perpendicular to the radial direction increases as the radial distance from the central axis A increases.

Alternatively, the electrode-coupling portion 310 may be configured such that, when viewed in the axial direction, the dimension of the electrode-coupling portion 310 along the circumferential direction increases as in the radial distance from the central axis A increases.

By increasing in size in the above manner at progressively larger radial distances, the electrode-coupling portion 310 may be considered to be define a “fan shape” as used herein.

The plurality of electrode-coupling portions 310 may be arranged rotationally-symmetrically with respect to the center of the can lid 300, which may be located on the central axis A of the winding center core C. Specifically, each of the electrode-coupling portions 310 may be formed with the same shape. Moreover, each of the electrode-coupling portions 310 may be and arranged so that an equal angle about the center of the can lid 300 (or central axis A) is defined therebetween in the circumferential direction. Stated another way, the electrode-coupling portions 310 may be spaced apart from each other along the circumferential direction so as to be positioned rotationally symmetrically about the central axis A. That is, the electrode coupling portions 310 may be arranged so as to have n-fold rotational symmetry about the central axis A. Thus, for example, in the case in which three electrode-coupling portions 310 are provided, the electrode coupling portions 310 would be arranged so as to have 3-fold rotational symmetry about central axis A

If the plurality of electrode-coupling portions 310 are formed and arranged symmetrically in the above manner, good abutting surface contact between the can lid 300 and the electrode assembly 100 may be more effectively achieved.

In some aspects, three electrode-coupling portions 310 may be provided. If three electrode-coupling portions 310 are provided, the plurality of electrode-coupling portions 310 may easily define a single plane, so that good abutting surface contact between the can lid 300 and the electrode assembly 100 may be more stably and easily achieved.

The electrode assembly 100 may be welded to the lower surface of the electrode-coupling portion 310. Specifically, the second uncoated portion 112b of the electrode assembly 100 (particularly when the foil tabs are radially bent to define a plane) may be welded to the lower surface of the electrode-coupling portion 310 while facing the electrode-coupling portion 310. The lower surface of the electrode-coupling portion 310 may define a flat shape. In such case, good abutting surface contact between the can lid 300 and the electrode assembly 100 may be achieved uniformly.

The electrode-coupling portion 310 may be formed with a constant thickness at each location within the plane extending perpendicularly to the central axis A. As a result, the same weldability and heat dissipation performance may be achieved at different locations along the electrode-coupling portion 310.

The can lid 300 may further include an injection port H and a flat portion 320.

The injection port H may be configured to open into the interior space of the cell housing 200. The injection port H may be configured so that the electrolyte can be injected into the cell housing 200 through the injection port H. The injection port H may be located substantially at the center of the can lid 300. The center of the injection port H may be the same as the center of the can lid 300. The center of the injection port H may be located on the central axis A of the winding center core C. The injection port H may be provided in a roughly circular shape.

The flat portion 320 may be configured to surround the injection port H. The flat portion 320 may, for example, surround the injection port H along the circumferential direction. The flat portion 320 may at least partially define a flat surface. For example, at least a portion of the upper surface of the flat portion 320 far from the electrode assembly 100 may define a flat shape. For example, at least a portion of the flat portion 320 may define a surface parallel to the XY plane.

The flat portion 320 may be spaced apart from the electrode assembly 100. For example, the lower surface of the flat portion 320 may be spaced apart from the electrode assembly 100 along the axial direction. As a result, an empty space may be defined between the flat portion 320 and the electrode assembly 100. If the flat portion 320 is configured in this manner, when the plug 330(explained later) is welded to the flat portion 320, the heat from that welding process may be substantially prevented from being directly transferred to the electrode assembly 100.

If the can lid 300 has an injection port H, electrolyte injection into the cell housing 200 may be easily and effectively performed. If the can lid 300 has a flat portion 320, the injection port H may be distinguished from other parts of the can lid 300, such as the electrode-coupling portion 310.

The radial length (L1) from the center of the can lid 300 to the radial outer end of the flat portion 320 may be 4 mm to 10 mm. Stated another way, the radial length (L1) may be from 8.79% to 22.0% of the length of the diameter of the can lid 300.

If the length (L1) is smaller than 4 mm, the area on which the plug 330 (explained later) is welded may be too small, which may result in welding defects and reduce the sealing of the injection port H. In addition, the flat surface of the flat portion 320 may not be smoothly produced.

In addition, if the length (L1) is greater than 10 mm, the resulting area occupied by the electrode-coupling portion 310 in the can lid 300 may be too small, so that the heat dissipation performance of the can lid 300 may be excessively deteriorated. In addition, the coupling between the can lid 300 and the electrode assembly 100 may be excessively low, and it may be difficult to achieve low resistance of the battery cell 10.

The flat portion 320 may have a mounting portion 342. The mounting portion 342 may be a portion where at least a portion of the plug 330 is mounted. The plug 330 may be configured to seal the injection port H. At least a portion of the plug 330 may be welded to the mounting portion 342. If the flat portion 320 is configured in this manner, sealing of the injection port H may be improved.

Meanwhile, the flat portion 320 may have an insert portion 341. The plug 330 may be inserted into the insert portion 341. The insert portion 341 and the mounting portion 342 may be collectively referred to as a plug-coupling portion 340. The plug 330 may have a protrusion 331 that protrudes to be inserted into the insert portion 341. The protrusion 331 may be coupled to the insert portion 341 in a press-fit manner. If the protrusion 331 is inserted into the insert portion 341, the injection port H may be sealed. The plug 330 may have an expansion portion 332 configured to be seated on the mounting portion 342. The expansion portion 332 may have a form like a flange that extends outward in the radial direction from the protrusion 331. The expansion portion 332 and the mounting portion 342 may be welded to each other.

The radial length (L2) of the flat portion 320, excluding the mounting portion 342 may be 2 mm to 4 mm. Stated another way, the radial length (L2) may be from 4.40% to 8.79% of the length of the diameter of the can lid 300.

If the length (L2) is smaller than 2 mm, it may not be possible to achieve the flat surface of the flat portion 320 all the way around the injection port H. In addition, when welding the mounting portion 342 and the plug 330, the corresponding welding heat may be excessively transferred to the electrode assembly 100. In addition, during the process of manufacturing the battery cell 10, when the can lid 300 is transported, the flat portion 320 may provide a surface for holding the can lid 300, for example, by vacuum suction. However, if the length (L2) is smaller than 2 mm, it may be difficult to achieve an area that can be vacuum-suctioned.

In addition, if the length (L2) is greater than 4 mm, the resulting area occupied by the electrode-coupling portion 310 in the can lid 300 may be too small, so that the heat dissipation performance of the can lid 300 may be excessively deteriorated. In addition, the coupling between the can lid 300 and the electrode assembly 100 may be excessively low, and it may be difficult to achieve low resistance of the battery cell 10.

The can lid 300 may have a bent portion 321 and an extension 311.

Specifically, the can lid 300 may have the above-described flat portion 320, and the flat portion 320 may have a bent portion 321. The bent portion 321 may be a recess that extends radially inwardly toward the central axis A. That is, when viewed in the axial direction, the bent portion 321 may be a recess that is concave towards the flat portion 320 and convex towards the injection port H. The bent portion 321 may constitute a feature defined along the radial outer edge of the flat portion 320. That is, the radial outer edge of the flat portion 320 may deviate radially inwardly to define the bent portion 321.

The electrode-coupling portion 310 of the can lid 300 may have an extension 311. The extension 311 may be a portion of the electrode-coupling portion 310 that extends radially inwardly within the recess defined by the bent portion 321. For example, the extension 311 may be a feature defined along the radial inner edge of the electrode-coupling portion 310 where the radial inner edge of the electrode-coupling portion 310 deviates radially inwardly to define the extension 311.

The extension 311 and the bent portion 321 may be defined by the same deviation in the common radial outer edge of the flat portion 320 and radial inner edge of the electrode-coupling portion 310, and thus extension 311 may have a shape corresponding to the bent portion 321. Specifically, as the bent portion 321 is recessed toward the injection port H, the extension 311 may correspondingly extend toward the injection port H.

In the can lid 300, if the flat portion 320 has a bent portion 321 and the electrode-coupling portion 310 has a extension 311 in the above manner, the radial length (L3), which is the welding length (LFW, Lid Foil tab welding) between the electrode-coupling portion 310 and the foil tab, may be maximized. For example, in the case of the can lid 300 without the bent portion 321 and the extension 311, the length (L3) may be approximately 9 mm. Meanwhile, in the case of the can lid 300 with the bent portion 321 and the extension 311, the length (L3) may be significantly longer, such as approximately 12 mm.

As the length (L3) is increased, the electrical resistance of the battery cell 10 may be reduced. Therefore, if the length (L3) is relatively long, the electrical resistance of the battery cell 10 may be beneficially reduced.

In addition, since the contact area between the can lid 300 and the electrode assembly 100 increases due to the presence of the extension 311 of the electrode-coupling portion 310, the heat dissipation performance of the can lid 300 may also be improved.

The can lid 300 may further include an edge portion 370. The edge portion 370 may be formed along the edge of the can lid 300 so as to be coupled to the cell housing 200. The edge portion 370 may be coupled to the opening 210 formed at one side of the cell housing 200 by a press-fitting method. That is, the edge portion 370 may be coupled to the cell housing 200 by being press-fit into the opening 210 and then welded to the side of the cell housing 200 surrounding the opening 210.

The cross-section of the edge portion 370 may be approximately U-shaped. For example, the cross-section of the edge portion 370 viewed in the circumferential direction (as shown in, for example, FIGS. 6-7) may have at least a portion that is convex towards the electrode assembly 100, and another portion may face the inner circumference of the cell housing 200.

When the edge portion 370 is press-fit into the opening 210 of the cell housing 200, it may be compressed and deformed inwardly in the radial direction. Accordingly, the edge portion 370 may come into close contact with the cell housing 200.

If the can lid 300 includes an edge portion 370 as described above, there is an advantage in that deformation or damage to other parts of the can lid 300, such as the electrode-coupling portion 310, may be minimized when the can lid 300 and the cell housing 200 are coupled. In addition, a better coupling between the can lid 300 and the cell housing 200 may be achieved. In addition, the tolerance between the can lid 300 and the cell housing 200 may be effectively resolved, as U-shaped the edge portion 370 may be radially compressed upon press-fitting into the opening 210 of the cell housing 200, such that the edge portion 370 conforms to the profile of the cell housing 200 and high adhesion between them may be achieved.

Meanwhile, the edge portion 370 may be spaced apart from the electrode assembly 100. Specifically, in a state in which the can lid 300 has been press-fit into the opening 210 of the cell housing 200, the end of the edge portion 370 closest to the electrode assembly 100 in the axial direction may be axially spaced apart from the electrode assembly 100. As a result, when welding the edge portion 370 and the cell housing 200, the heat from that welding process may be substantially prevented from being directly transferred to the electrode assembly 100.

The can lid 300 may further include at least one separated portion 360.

The separated portion 360 may be configured to at least partially partition two neighboring electrode-coupling portions 310 from each other. The separated portion 360 may be arranged between any two neighboring electrode-coupling portions 310. For example, if the can lid 300 has three electrode-coupling portions 310 arranged in the circumferential direction, the separated portion 360 may be arranged between any two electrode-coupling portions 310 that are adjacent in the circumferential direction.

The separated portion 360 may be structured so as to be spaced apart from the electrode assembly 100 along the axial direction. Specifically, the separated portion 360 may be arranged to be spaced apart from the electrode assembly 100 at a position relatively farther from the electrode assembly 100 than the electrode-coupling portion 310. For example, the separated portion 360 may be arranged further upward or in the +Z direction from the electrode assembly 100 than the electrode-coupling portion 310.

If the can lid 300 further includes at least one separated portion 360 as above, there is an advantage in that a plurality of electrode-coupling portions 310 may be reliably partitioned and spaced from each other. If a plurality of electrode-coupling portions 310 are reliably partitioned, good abutting surface contact between the can lid 300 and the electrode assembly 100 may be achieved more stably and evenly.

In addition, an empty space may be defined between the separated portion 360 and the electrode assembly 100, so that an electrolyte movement path and various gas accommodation spaces may result. In addition, when welding one electrode-coupling portion 310 adjacent to the separated portion 360, the heat from that welding process may be substantially prevented from being directly transferred to another adjacent electrode-coupling portion 310.

The separated portion 360 may be arranged at a radial position closer to the outer periphery of the can lid 300 than the center of the can lid 300. For example, the separated portion 360 may be arranged at a position adjacent to the edge portion 370. For example, the separated portion 360 may be positioned further outward in the radial direction than the bridge 350, explained later. The separated portion 360 may have a shape that is elongated radially inwardly toward the center of the can lid 300, for example.

The radial inner end of the separated portion 360 may be have a curved shape. For example, the inner end of the separated portion 360, which forms a boundary with the bridge 350 (explained later) may be formed in a curved shape. As a result, the radial rigidity of the can lid 300 may be improved. In addition, when forming the separated portion 360, such as by pressing or stamping the can lid 300 (e.g., using appropriately shaped press and die components), the processing difficulty and the possibility of damage and defects to the can lid 300 may be reduced.

The can lid 300 may further include at least one bridge 350.

The bridge 350 may be configured to at least partially partition two neighboring electrode-coupling portions 310. The bridge 350 may be arranged between any two neighboring electrode-coupling portions 310. For example, if three electrode-coupling portions 310 are arranged in the circumferential direction, the bridge 350 may be arranged between every two electrode-coupling portions 310 that are adjacent in the circumferential direction.

The bridge 350 may be positioned radially inwardly from the separated portion 360 described above. For example, the bridge 350 may be disposed between the center of the can lid 300 and the separated portion 360. For example, the bridge 350 may be positioned between the flat portion 320 and the separated portion 360 in the radial direction. The bridge 350 may extend, for example, radially inward from the separated portion 360 toward the center of the can lid 300. The bridge 350 may extend, for example, radially outward from the flat portion 320.

The bridge 350 may be structured so as to be spaced apart from the electrode assembly 100 along the axial direction. Specifically, the bridge 350 may be disposed spaced apart from the electrode assembly 100 at a position relatively farther from the electrode assembly 100 than the electrode-coupling portion 310. For example, the bridge 350 may be disposed further upward or in the +Z direction from the electrode assembly 100 than the electrode-coupling portion 310.

If the can lid 300 further includes at least one bridge 350 as described above, there is an advantage in that a plurality of electrode-coupling portions 310 may be reliably partitioned from each other. If the plurality of bridges 350 are reliably partitioned, good abutting surface contact between the can lid 300 and the electrode assembly 100 may be achieved more stably and evenly.

The gap between the bridge 350 and the electrode assembly 100 in the axial direction may be smaller than the axial gap between the separated portion 360 and the electrode assembly 100.

In addition, an empty space may be defined between the bridge 350 and the electrode assembly 100, so that an electrolyte movement path and various gas accommodation spaces may result. In addition, when welding one electrode-coupling portion 310 adjacent to the bridge 350, the heat from that welding process may be substantially prevented from being directly transferred to another adjacent electrode-coupling portion 310. In addition, the overall rigidity of the can lid 300 may be reinforced by the bridge 350.

Like the electrode-coupling portions 310, the separated portion 360 and/or the bridge 350 described above may be arranged rotationally-symmetrically with respect to the center of the can lid 300. The can lid 300 may be configured in a radially rotationally-symmetrical shape with respect to the center of the can lid 300. As a result, the rigidity of the can lid 300 may be enhanced, and the productivity, electrical stability, and heat dissipation performance of the battery cell 10 may all be improved.

Referring to FIG. 5, the can lid 300 may further include an indicator portion ID. The indicator portion ID may display product information of the battery cell 10. Such product information may include various information related to the production and manufacturing of the battery cell 10. Accordingly, the corresponding battery cell 10 may be tracked by the indicator portion ID.

The indicator portion ID may be configured to have, for example, a barcode or a QR code. Such barcode or QR code of the indicator portion ID may be provided in an etched form by etching the surface of the can lid 300 at the location of the indicator portion ID.

The electrode-coupling portion 310 is a portion where welding is performed with the electrode assembly 100, and thus the electrode-coupling portion 310 may not be suitable a suitable location for positioning the indicator portion ID, as the welding may damage the indicator portion ID if positioned in that location. Therefore, it may be appropriate that the indicator portion ID is provided elsewhere in one of the remaining portions of the can lid 300, i.e., other than the electrode-coupling portion 310.

For example, the indicator portion ID may be provided on the separated portion 360. For example, the indicator portion ID may be provided on the bridge 350. For example, the indicator portion ID may be provided on the flat portion 320. For example, the indicator portion ID may be provided on at least one of the separated portion 360, the bridge 350, and the flat portion 320.

The indicator portion ID may be provided on the upper surface of the can lid 300 in a region spaced axially away from the electrode assembly 100.

If the indicator portion ID is arranged as above, the area efficiency of the can lid 300 may be improved. Here, area efficiency may mean how efficiently a specific area is utilized.

However, the indicator portion ID is not limited to the above and may be provided at various other locations. For example, the indicator portion ID may be provided on the lower surface of the can lid 300, which is close to the electrode assembly 100 in the can lid 300. For example, the indicator portion ID may be provided on the outer circumference or inner circumference of the cell housing 200. For example, the indicator portion ID may be provided along the closed surface of the cell housing 200, on at least one of the upper surface close to the electrode assembly 100 and the lower surface far from the electrode assembly 100.

In addition, one or more indicator portions ID may be provided. For example, a plurality of the indicator portions ID may be provided, and the plurality of indicator portions ID may be provided at different locations of the battery cell 10.

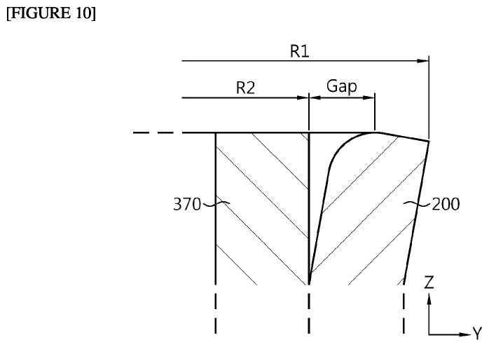

FIG. 8 is an enlarged side cross-sectional view showing the closed portion of the cell housing of FIG. 3.

Hereinafter, with reference to FIGS. 3, 5, and 8, the venting structure of the battery cell 10 according to an aspect of the present disclosure will be described in detail.

In particular, referring to FIG. 5, the can lid 300 may be configured with a non-venting structure. That is, the can lid 300 may not have a structure for venting.

If a thermal event occurs in the battery cell 10, the pressure inside the battery cell 10 may increase due to high-temperature and high-pressure gas. A structure for venting, as referred to herein, may mean a structure that may be ruptured by the internal pressure of the battery cell 10 so as to release the high-pressure gas therethrough. For example, the structure for venting may be a notched structure that may be ruptured when the internal pressure of battery cell 10 exceeds a threshold value.

The can lid 300 of the battery cell 10 according to an aspect of the present disclosure may not have a structure for venting, such as by configuring the can lid 300 without any notching.

In the case of a conventional battery cell, a structure for venting may be provided on the can lid. For example, the can lid of a conventional battery cell could have a notched portion for venting, such as a vent notch portion. In addition, when a battery cell is configured as a battery module or a battery pack, a venting space for directing the flow of the vented gas may be provided along the can lid of the battery cell inside the module or pack. As a result, it is difficult to arrange a cooling member for cooling the battery cell at the can lid. Therefore, in the case of a conventional battery cell, when the can lid is configured as the bottom, it is difficult to implement a cooling structure using a bottom cooling method in which a cooling member is arranged along the bottom.

However, in the battery cell 10 according to the present disclosure, since the can lid 300 is not configured with a venting structure, as described above, a cooling member may be arranged along the can lid 300 of the battery cell 10 when fabricating a module or pack containing one or more of the battery cells 10, and a separate venting space may no longer be necessary along the can lid 300, thereby enabling the implementation of effective bottom cooling.

If a structure for venting were to be provided in the can lid 300 and a cooling member were arranged along the can lid 300, the can lid 300 may not be properly ruptured due to interference from the cooling member, despite the internal pressure of the battery cell 10 increasing.

Referring to FIG. 8, the cell housing 200 may have a vent notch portion 230. Specifically, the closed portion 220 of the cell housing 200 may have a vent notch portion 230. The vent notch portion 230 is a structure for venting and may be configured to rupture when the internal pressure of the battery cell 10 becomes higher than a threshold value due to the high-temperature and high-pressure gas inside the battery cell 10. The vent notch portion 230 may be formed by notching at least one of both surfaces of the closed portion 220. The vent notch portion 230 may be formed by notching along, for example, a circumferential direction.

In this case, a structure for venting may be provided at the opposite side of the can lid 300, where the can lid 300 may be configured as the bottom of the battery cell 10 (as discussed above), so that bottom cooling of the battery cell 10 may be implemented more effectively.

As described above, both the terminal of the first polarity and the terminal of the second polarity may be positioned along the closed portion 220. Accordingly, an electrical connection structure between the plurality of battery cells 10 may be configured at the opposite axial end of the battery cell 10 from the can lid 300. As a result, cooling structures may be arranged at the can lid 300 end of the battery cell 10 without interference from other structures, such as electrical connection structures, thereby helping to effectively implement bottom cooling.

On the other hand, if the closed portion 220 were to be configured as the bottom and a cooling member were placed along the closed portion 220, it may be difficult to implement an electrical connection structure between the plurality of battery cells 10 due to the presence of that cooling member.

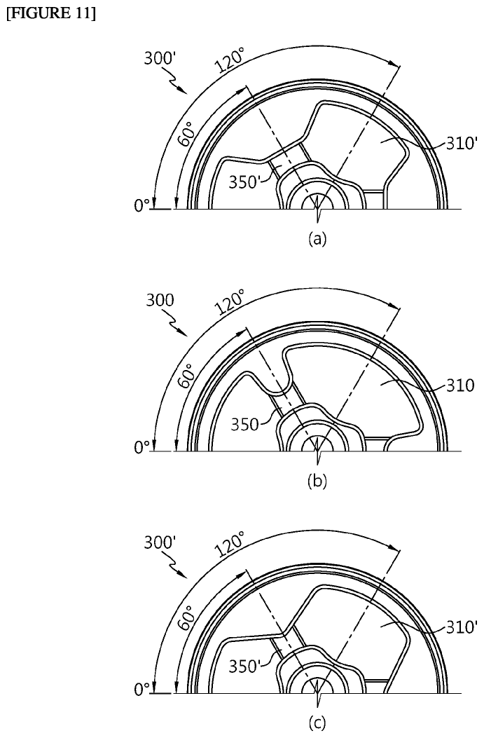

FIG. 9 is an exaggerated enlarged side cross-sectional view representing an expanded state of the can lid.

Hereinafter, with reference to FIG. 9, a case in which the battery cell 10 is bulged will be described.

If the internal pressure of the battery cell 10 increases, the battery cell 10 may expand. In this case, the can lid 300 in particular may swell. FIG. 9 is a cross-sectional view illustrating how a portion of the can lid 300 deforms under increased internal pressure within the battery cell 10.

When the battery cell 10 expands, the expansion performance may be defined as the performance indicating how low the total height of the battery cell 10 is under the same internal pressure conditions. In other words, under the same internal pressure conditions, a lower total height of the battery cell 10 would indicate a higher expansion performance.

Referring to FIGS. 6, 7, and 9, at least a portion of the outer surface of the flat portion 320 may be recessed toward the electrode assembly 100 in the axial direction. Here, the outer surface of the flat portion 320 may refer to an upper surface of the flat portion 320 that is far from the electrode assembly 100. That is, at least a portion of the upper surface of the flat portion 320 may be recessed toward the electrode assembly 100. For example, at least a portion of the upper surface of the flat portion 320, which is adjacent to the injection port H may be recessed toward the electrode assembly 100. For example, the mounting portion 342 on which the expansion portion 332 of the plug 330 is seated may have an axially recessed shape toward the electrode assembly 100.

The axial depth of the recess of at least a portion of the outer surface of the flat portion 320 (e.g., the recessed depth of the mounting portion 342) may be, for example, about 0.1 mm. However, the recessed depth may be smaller or larger than this.

The recessed depth of the mounting portion 342 may be greater than, for example, the thickness of the expansion portion 332 of the plug 330. In such case, the upper surface of the expansion portion 332 seated on the mounting portion 342 may have a lower height than the upper surface of the flat portion 320.

If at least a portion of the outer surface of the flat portion 320 is formed by being recessed in this way, the total height of the radially central portion of the battery cell 10 aligned along the central axis A may be lower when the battery cell 10 expands than it would have without the aforementioned recess, and as a result the expansion performance of the battery cell 10 may be improved.

Referring to FIGS. 7 and 9, the axial height difference (h3) between the electrode-coupling portion 310 and the separated portion 360 may be 0.6 mm to 1.3 mm.

If the height difference (h3) is smaller than 0.6 mm, it may be difficult for the edge portion 370 to have a sufficient size, and thus the coupling between the can lid 300 and the cell housing 200 may be poor. In addition, the can lid 300 may not be sufficiently rigid.

On the other hand, if the height difference (h3) is greater than 1.3 mm, it may become difficult to form the separated portion 360 when pressing or stamping the can lid 300. In addition, if the height difference (h3) is too high, a portion of the can lid 300 corresponding to the separated portion 360 may protrude too high when the battery cell 10 expands, which may excessively deteriorate the expansion performance of the battery cell 10.

Considering the above points, the height difference (h3) may be preferably in a range from 0.9 mm to 1.2 mm.

Referring to FIGS. 6 and 9, the portion of the edge portion 370 that is spaced furthest from the electrode assembly 100 may be configured to have a predetermined height difference (h2) with respect to the remaining portion of the can lid 300 that is farthest from the electrode assembly 100. Specifically, the upper end of the edge portion 370 may be positioned higher than the uppermost portion of the remaining portion of the can lid 300 by the height difference (h2). Here, the upper end of the edge portion 370 may be formed along the outermost portion of the can lid 300 in the radial direction. Therefore, the outermost portion of the can lid 300 may be the highest portion of the can lid 300. If the can lid 300 is configured in this manner, even if the central portion of the can lid 300 swells upwardly when the battery cell 10 expands, there may be practically no change in the total height of the battery cell 10 up to the height difference (h2), such that the expansion performance of the battery cell 10 may be improved.

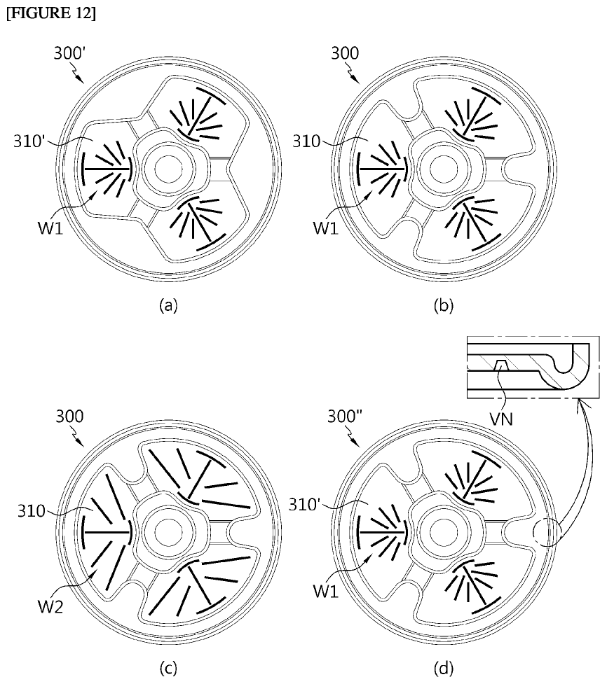

FIG. 10 is an exaggerated side cross-sectional view representing a state where a gap occurs between the can lid and the cell housing, and FIG. 11 includes partial plan views comparing the degree of gap formation between a comparative can lid and the can lid according to the present disclosure.

Hereinafter, with reference to FIGS. 10 and 11, the phenomenon of gap formation between the can lid 300 and the cell housing 200 will be described.

First, FIG. 10 is a side cross-sectional view, and FIG. 10 shows an enlarged view of the upper end of the can lid 300 and the cell housing 200 in a press-fit state. Referring to FIG. 10, when the diameter of the cell housing 200 is R1 and the diameter of the can lid 300 (or the diameter of the edge portion 370) is R2, a gap may be formed between the cell housing 200 and the edge portion 370. The gap may increase along the axially upward direction, and the maximum value of the gap may be formed at the uppermost portion between the cell housing 200 and the edge portion 370.

It is believed that this gap is created as the lower portion of the edge portion 370 pushes the cell housing 200 outward in the radial direction when the edge portion 370 is forcibly press-fit into the cell housing 200. Ideally such gap would be minimized, since a larger gap makes welding more difficult (as the weld must bridge a larger space between components to be welded to each other) and also leads to lower strength of the welded connection. As a result of such lower strength, the battery cell 10 will have worse expansion performance.

Hereinafter, with reference to FIG. 11, the degree of gap formation of the comparative can lid 300′ and the can lid 300 according to the present disclosure will be comparatively explained.

Part (a) of FIG. 11 is a drawing for explaining the gap of a comparative can lid 300′ as Case 1. In the comparative can lid 300′ of Case 1, a width of the bridge 350′ (width in the direction perpendicular to the radial direction when viewed along the axial direction) is 6 mm. In the comparative can lid 300′ of Case 1, the electrode-coupling portion 310′ is not formed in a fan shape, but rather the width of the electrode-coupling portion 310′ perpendicular to the radial direction is generally constant along the radial direction.

Part (b) of FIG. 11 is a drawing for explaining the gap of the can lid 300 according to the present disclosure as Case 2. In the can lid 300 of Case 2, a width of the bridge 350 is 5 mm. As described above, in Case 2, the electrode-coupling portion 310 is formed in a fan shape.

Part (c) of FIG. 11 is a drawing for explaining the gap of a comparative can lid 300′ as Case 3. The can lid 300′ of Case 3 has a similar shape to Case 1, in that the electrode-coupling portion 310′ has the same shape as that in Case 1, except the width of the bridge 350′ is the same as in Case 2, i.e., 5 mm.

After forcibly fitting the can lid 300, 300′ of Cases 1 to 3 into the cell housing 200 of the same shape, a FEM (Finite Element Method) analysis was performed to calculate the maximum radius and maximum gap of the cell housing 200 for each case. The FEM analysis was performed using a commercially available simulation tool, i.e., Abaqus. For reference, for each case, the angle of the line passing longitudinally along the middle of any one bridge 350, 350′ from the center of the can lid 300, 300′ was set to 60 degrees. Based on this, the counterclockwise and clockwise angles were set to 0 degrees and 120 degrees, respectively.

As a result of the FEM analysis, in each case, after the can lid 300, 300′ was forcibly press-fit into the opening 210 of the cell housing 200, the radius of the cell housing 200 was calculated to be symmetrical in the left and right circumferential directions with respect to the 60 degree angle. In each case, it was calculated that, the maximum radius of the cell housing 200 occurs at the point where the rigidity of the can lid 300, 300′ in the radial direction is the greatest.

In Case 1 and Case 3, the maximum radius of the cell housing 200 occurred at approximately 25 degrees after the press-fitting, and was calculated as 23.1824 mm and 23.1823 mm, respectively. In Case 2, the maximum radius of the cell housing 200 occurred at approximately 50 degrees, and was calculated as 23.1821 mm. In other words, after the press-fitting, the maximum radius of the cell housing 200 in the three cases was calculated to increase from lowest to highest in the following order: Case 2, Case 3, and Case 1.

Next, after the can lid 300, 300′ was press-fit into the opening 210 of the cell housing 200, a FEM analysis was performed to calculate the maximum value of the gap between the can lid 300, 300′ and the cell housing 200 (i.e., the radial gap at the top of the can lid 300, 300′ and the top of the cell housing 200 shown in FIG. 10). The FEM analysis was performed using the same commercially available simulation tool noted above, i.e., Abaqus.

As a result of the FEM analysis, in Case 1, the maximum value of the gap was calculated as 0.2528 mm at the 3 degree point. In Case 2, the maximum value of the gap was calculated as 0.2558 mm at the 41 degree point. In Case 3, the maximum value of the gap was calculated as 0.2535 mm at the 3 degree point. Thus, the maximum values of the gap in the three cases was calculated to increase from lowest to highest in the following order: Case 1, Case 3, and Case 2.

Comparing the FEM analysis results of Case 1 and Case 3, it may be seen that when the shape of the electrode-coupling portion 310′ is maintained the same, the resulting gap formed is larger when the width of the bridge 350′ is smaller. Comparing the FEM analysis results of Case 2 and Case 3, it may be seen that when the width of the bridge 350, 350′ is the same, the gap formed is larger when the area of the electrode-coupling portion 310, 310′ is larger.

FIG. 12 includes plan views for comparing the heat dissipation performance of a first comparative can lid, the can lid according to the present disclosure, and another, second comparative can lid.

Hereinafter, with reference to FIG. 12, the heat dissipation performance of the first comparative can lid 300′, the can lid 300 according to the present disclosure, and the second comparative can lid 300′ will be comparatively described. It is noted that Cases 1 to 3 of FIG. 12 mentioned below are not the same as Cases 1 to 3 of FIG. 11.

Part (a) of FIG. 12 is a drawing for explaining the heat dissipation performance of the first comparative can lid 300′ as Case 1. The first comparative can lid 300′ of part (a) FIG. 12 may have the same shape as the comparative can lid 300′ of part (c) of FIG. 11. The first comparative can lid 300′ of Case 1 is coupled to the electrode assembly 100 using the first welding pattern W1.

Part (b) of FIG. 12 is a drawing for explaining the heat dissipation performance of the can lid 300 according to the present disclosure as Case 2. The can lid 300 of Case 2 according to the present disclosure is coupled to the electrode assembly 100 using the same first welding pattern W1.

Part (c) of FIG. 12 is a drawing for explaining the heat dissipation performance of the can lid 300 according to the present disclosure as Case 3. The can lid 300 of Case 3 according to the present disclosure is coupled to the electrode assembly 100 using a second welding pattern W2. The second welding pattern W2 is a welding pattern similar to the first welding pattern W1, except extending out wider transverse to the radial direction than W1. If the first welding pattern W1 may be referred to as a “Pine” pattern, and the second welding pattern W2 may be referred to as a “Wide Pine” pattern.

Part (d) of FIG. 12 is a drawing for explaining the heat dissipation performance of the second comparative can lid 30041 as Case 4. The second comparative can lid 300″ of Case 4 may be the same as that of Case 2, except for the additional presence of vent notch portion VN in the second comparative can lid 300″ of Case 4. That is, in the can lid 300″ of Case 4, a vent notch portion VN is notched in an area close to the edge portion and extends circumferentially about the can lid 30041 .

A FEM analysis was performed to calculate the thermal conductivity [W/K] of each can lid 300, 300′, 300″ corresponding to Cases 1 to 4. The FEM analysis was performed using a commercially available simulation tool, i.e., ANSYS Fluent. The FEM analysis was performed under the condition that battery cells 10 including each can lid 300, 300′, 300″ were cooled with coolant, where the inlet temperature of the coolant (i.e., the minimum temperature) was set to 20 °C. The thermal conductivity of the can lid 300, 300′, 300″ was calculated by dividing the total heat generation of the corresponding battery cells 10 by the difference between the maximum temperature of the electrode assembly 100 and the inlet temperature of the coolant.

In Case 1the total heat generation of the battery cell 10 was 6.0444 W, the maximum temperature of the electrode assembly 100 was 43.41 °C, and the thermal conductivity of the can lid 300′ was calculated to be 0.2582 W/K.

For Case 2, the total heat generation of the battery cell 10 was 5.8856 W, the maximum temperature of the electrode assembly 100 was 42.36 °C, and the thermal conductivity of the can lid 300 was calculated to be 0.2632 W/K.

For Case 3, the total heat generation of the battery cell 10 was 6.0066 W, the maximum temperature of the electrode assembly 100 was 42.57 °C, and the thermal conductivity of the can lid 300 was calculated to be 0.2661 W/K.

For Case 4, the total heat generation of the battery cell 10 was 6.0590 W, the maximum temperature of the electrode assembly 100 was 43.23 °C, and the thermal conductivity of the can lid 300″ was calculated to be 0.2608 W/K.

Comparing the FEM analysis results of Case 1 and Case 2, it may be seen that when the area of the electrode-coupling portion 310, 310′ is larger, the heat dissipation performance of the can lid 300, 300′ is better. Therefore, it may be seen that the area of the electrode-coupling portion 310, 310′ is closely related to the heat dissipation performance of the can lid 300, 300′.

Comparing the FEM analysis results of Case 2 and Case 3, it may be seen that when the welding pattern between the can lid 300 and the electrode assembly 100 is formed over a larger area (i.e., more widely in the circumferential direction), the heat dissipation performance of the can lid 300 is better.

Comparing the FEM analysis results of Case 2 and Case 4, it may be seen that the heat dissipation performance of the can lid 300, 300″ is better when the vent notch portion VN is not provided on the can lid 300, 300″. This result is expected to be due to the resulting bottleneck shape (see enlarged cross-section associated with part (d) of FIG. 12) that the heat and current must flow through when the vent notch portion VN is present on the can lid 300, 300″.

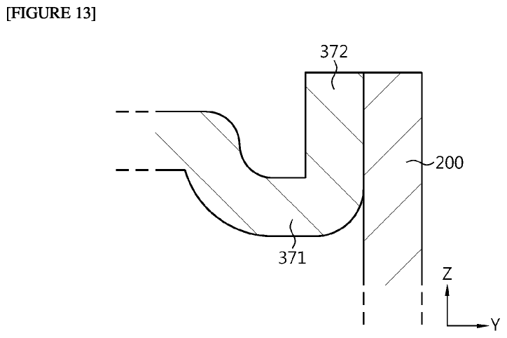

FIG. 13 is an enlarged side cross-sectional view showing an edge portion of a can lid according to another aspect of the present disclosure.

Hereinafter, with reference to FIGS. 10, 11, and 13, a battery cell 10 according to another aspect of the present disclosure will be described. The edge portion 370 of the can lid 300 of the battery cell 10 according to this other aspect of the present disclosure may include an outer wall 372 and a convex portion 371.

The outer wall 372 may be a portion that is coupled to the inner circumference of the cell housing 200. The outer wall 372 may be provided at the outermost side of the edge portion 370 in the radial direction. The outer wall 372 may be welded while facing and abutting the inner circumference of the cell housing 200.

The convex portion 371 may be a portion having a convex shape toward the electrode assembly 100. An end of the convex portion 371 closest to the electrode assembly 100 may be spaced apart from the electrode assembly 100 along the axial direction.

The outer wall 372 and the convex portion 371 may also be provided in the can lid 300 of the battery cell 10 according to the earlier-discussed aspects of the present disclosure.

In the can lid 300 of the battery cell 10 according to the aspect of the present disclosure illustrated in FIG. 13, a cross-section of the outer edge defined by the region where the outer wall 372 and the convex portion 371 are connected may have a right angle shape. Such cross-section may be a cross-section viewed in the circumferential direction, as illustrated in FIG. 13. The outer edge may define a corner spaced away from the electrode assembly 100 along the axial direction.

If the cross section of the outer edge between the outer wall 372 and the convex portion 371 has a right angle shape in this way, the outer wall 372 may be more closely attached to the inner circumference of the cell housing 200, so that the gap between the can lid 300 and the cell housing 200 may be reduced (see FIG. 10).

Referring to FIGS. 5, 10, 11 and 12, the circumferential width (L4) of the separated portion 360 may be 3 mm to 20 mm. Stated another way, the circumferential width (L4) of the separated portion 360 may be from 6.59% to 44.0% of the length of the diameter of the can lid 300.

The radial outer edge of the electrode-coupling portion 310 may be formed as a curved portion having a center of curvature that coincides with the center of the can lid. Also, from a circumferential end of the curved portion, the edge of the electrode-coupling portion may begin to bend inward in the radial direction. Here, the circumferential width (L4) of the separated portion 360 may be the circumferential width between the circumferential end of the curved portion of one electrode-coupling portion and the circumferential end of the curved portion of the other electrode-coupling portion among two neighboring electrode-coupling portions.

If the width (L4) is less than 3 mm, the above-described gap between the can lid 300 and the cell housing 200 (shown in FIG. 10) may be excessively large. On the other hand, if the width (L4) is larger than 20 mm, the area of the electrode-coupling portion 310 may be too small, such that the heat dissipation performance of the can lid 300 may be excessively deteriorated.

In order to alleviate the gap between the can lid 300 and the cell housing 200, it may be desirable that the width (L4) is in a range from 10 mm to 20 mm. Stated another way, it may be desirable that the width (L4) is in a range from 22.0% to 44.0% of the length of the diameter of the can lid 300. On the other hand, in order to maximize the heat dissipation performance of the can lid 300, it may be desirable that the width (L4) is in a range from 3 mm to 10 mm. Stated another way, it may be desirable that the width (L4) is in a range from 6.59% to 22.0% of the length of the diameter of the can lid 300. Considering both competing goals, then (i.e., in order to simultaneously minimize the gap between the can lid 300 and the cell housing 200 while also maximizing the heat dissipation performance of the can lid 300), the width (L4) may be, for example, in a range from 6 mm to 15 mm. Stated another way, the width (L4) may preferably be in a range from 13.2% to 33.0% of the length of the diameter of the can lid 300.

Referring to FIGS. 5, 10, 11 and 12, when viewed along the axial direction, the width (L5) of the bridge 350 in the direction perpendicular to the radial direction may be 2 mm to 10 mm. Stated another way, the width (L5) of the bridge 350 may be in a range from 4.40% to 22.0% of the length of the diameter of the can lid 300.

If the width (L5) is less than 2 mm, the formation of the bridge 350, such as during pressing or stamping of the can lid 300, may become difficult. In addition, the gap between the can lid 300 and the cell housing 200 may become excessively large, since the radial rigidity of the can lid 300 may not be sufficient.

On the other hand, if the width (L5) is larger than 10 mm, the area of electrode-coupling portion 310 may become excessively small, and the heat dissipation performance of the can lid 300 may be excessively deteriorated.

Referring to FIGS. 5, 10, 11, and 12, when viewed along the axial direction, the area occupied by the plurality of electrode-coupling portions 310 in the can lid 300 may be from 0.25 to 0.50 of the total area of the can lid 300. That is, when viewed in a plan view, the ratio of the total area occupied by the plurality of electrode-coupling portions 310 to the total area of the can lid 300 may be 0.25 to 0.50. Stated another way, the ratio of the total area occupied by the plurality of electrode-coupling portions 310 to the total area of the can lid 300 may be 25% to 50%. If that ratio were to be less than 0.25, the area of the electrode-coupling portion 310 may become excessively small, resulting in the heat dissipation performance of the can lid 300 being excessively deteriorated. On the other hand, if that ratio were to exceed 0.50, the gap between the can lid 300 and the cell housing 200 may become excessively large.

Referring to FIGS. 7 and 9, the axial height of the bridge 350 may be higher than the electrode-coupling portion 310 and lower than the separated portion 360. Specifically, the height (h4) from the lower surface of the electrode-coupling portion 310 to the lower surface of the bridge 350 may be greater than 0, but may be less than the height (h3) from the lower surface of the electrode-coupling portion 310 to the lower surface of the separated portion 360.

If the can lid 300 is configured in the above way, the radial stiffness of the can lid 300 may be increased, so that the gap between the can lid 300 and the cell housing 200 may be effectively reduced. In addition, configuring the can lid 300 in the above manner may make the forming process for forming the can lid 300 (such as by pressing or stamping) easier to achieve, so that manufacturing productivity may be improved and the defect rate of the can lid 300 may be reduced.

Furthermore, configuring the can lid 300 in the above manner may also improve expansion performance of the battery cell, as the total height at the bridge 350 may be remain low when the battery cell 10 expands due to internal pressure. In addition, as the overall rigidity of the can lid 300 increases, the strain induced by the stress of the internal pressure of the battery cell 10 may be reduced, such that the expansion performance of the battery cell 10 may be improved.

The axial height difference between the electrode-coupling portion 310 and the bridge 350 (i.e., the height (h4) from the lower surface of the electrode-coupling portion 310 to the lower surface of the bridge 350) may be 0.3 mm to 1.0 mm. If the height (h4) is less than 0.3 mm, forming processes such as pressing or stamping of the can lid 300 may become difficult, and thus manufacturing productivity may decrease and the defect rate of the can lid 300 may increase. On the other hand, if the height (h4) is greater than 1.0 mm, the gap between the can lid 300 and the cell housing 200 may become excessively large. In addition, the expansion performance of the battery cell 10 may become excessively low. This may be due to the can lid 300 having weaker rigidity.

The axial height difference between the bridge 350 and the separated portion 360 (i.e., the height (h5) from the lower surface of the bridge 350 to the lower surface of the separated portion 360) may be 0.2 mm to 0.3 mm. If the height (h5) is less than 0.2 mm, the gap between the can lid 300 and the cell housing 200 may increase. In addition, the battery cell 10 may have poor expansion performance. On the other hand, if the height (h5) is greater than 0.3 mm, the process of forming the can lid 300, such as by pressing or stamping, may become difficult.

Referring to the enlarged portion of FIG. 4, the can lid 300 may include a wall portion SW and a first round portion R1.

The wall portion SW may be a portion extending away from the electrode assembly 100 along the axial (or Z-axis) direction from at least a part of an edge of the electrode coupling portion 310. As described above, the electrode coupling portion 310 may be formed to be recessed toward the electrode assembly 100 along the axial direction. The wall portion SW may be configured to surround at least a part of the edge of the recessed electrode coupling portion 310.

The first round portion R1 may be formed at an outer boundary between the wall portion SW and the electrode coupling portion 310. Here, the “outer boundary” refers to a boundary that faces outward from the battery cell 100 (away from interior space of the cell housing 200), at the junction between the wall portion SW and the electrode coupling portion 310.

The first round portion R1 may have a rounded shape. A radius of curvature of the first round portion R1 may be in a range of 0.05 mm to 0.30 mm.

If the radius of curvature of the first round portion R1 is less than 0.05 mm, a forming process of the can lid 300, such as pressing or stamping for forming the electrode coupling portion 310, may become excessively difficult.

On the other hand, if the radius of curvature of the first round portion R1 is greater than 0.30 mm, an area occupied by the electrode coupling portions 310 in the can lid 300 may become excessively small.

The radius of curvature of the first round portion R1 may preferably be, for example, in a range of 0.10 mm to 0.20 mm.

The can lid 300 may include a first wall portion SW1, a second wall portion SW2, and a second round portion R2, R2′.

The first wall portion SW1 may be a portion extending away from the electrode assembly 100 from an edge of the electrode coupling portion 310, specifically from a radially outer edge of the electrode coupling portion 310. The first wall portion SW1 may have a shape extending, for example, along a circumferential direction.

The second wall portion SW2 may be a portion extending away from the electrode assembly 100 from an edge of the electrode coupling portion 310 that extends toward the central axis A of the winding center core C. The second wall portion SW2 may have a shape extending, for example, substantially in a radial direction toward the central axis A.

The above-described wall portion SW may include the first wall portion SW1 and the second wall portion SW2.

A corner wall portion CW may be provided between the first wall portion SW1 and the second wall portion SW2. The corner wall portion CW may be connected to the first wall portion SW1, the second wall portion SW2, and the electrode coupling portion 310, and may be a portion extending generally axially away from the electrode assembly 100 along the Z-axis direction.

Second round portions R2, R2′ may be formed along an outer boundary of the can lid 300 extending between the first wall portion SW1 and the second wall portion SW2. Here, the “outer boundary” gain refers to a boundary that faces outward from the battery cell 100 away from the interior space of the cell housing 200, where the second round portions R2, R2′ extend along the corner between the first wall portion SW1 and the second wall portion SW2.

The second round portions R2, R2′ may have a rounded shape. Specifically, the second round portion R2 at the lower end of the corner wall portion CW (i.e., the end at the same height in the Z-axis direction as the surface of the electrode coupling portion 310 that faces outwardly/upwardly), a radius of curvature of the second round portion R2 may be formed in a range of 1.0 mm to 5.0 mm.

During a forming process of the can lid 300, such as pressing or stamping for forming the electrode coupling portion 310, deformation may be concentrated in a region between the first wall portion SW1 and the second wall portion SW2 (e.g., the corner wall portion CW), and a so-called necking phenomenon may occur.

If the radius of curvature of the second round portion R2 is less than 1.0 mm, it may be difficult to prevent the occurrence of the necking phenomenon in the region between the first wall portion SW1 and the second wall portion SW2.

On the other hand, if the radius of curvature of the second round portion R2 is greater than 5.0 mm, an area occupied by the electrode coupling portions 310 in the can lid 300 may become excessively small.

The radius of curvature of the second round portion R2 may preferably be, for example, in a range of 2.0 mm to 4.0 mm.

The radius of curvature of the second round portions R2, R2′ may be selected to be larger at further distances from the electrode assembly 100.

For example, a radius of curvature of the second round portion R2′ at the upper portion of the corner wall portion CW (i.e., the portion at a height spaced upwardly in the +Z direction from the outer surface of the electrode coupling portion 310) may be greater than the radius of curvature of the second round portion R2 at the lower end of the corner wall portion CW.

When the radius of curvature of the second round portions R2, R2′ is configured as described above, the occurrence of the necking phenomenon in the region between the first wall portion SW1 and the second wall portion SW2 may be more effectively prevented.

FIG. 14 includes partial plan views for comparing the degree of gap formation across different can lid shapes according to other aspects of the present disclosure.

Hereinafter, with reference to FIG. 14, the can lid 300 of the battery cell 10 according to other aspects of the present disclosure will be described in detail.

The electrode-coupling portion 310 of the can lid 300 according to other aspects of the present disclosure may be configured in a more rounded shape than the electrode-coupling portions 310 of the can lid 300 according to the above aspects of the present disclosure.

Specifically, in the can lid 300 according to the aspects of the disclosure illustrated in parts (a)-(d) of FIG. 14, a center of curvature of the curved edge forming the radial outer edge of the electrode-coupling portion 310 may be located between the center of the can lid 300 and the curved edge in the radial direction. For reference, in the electrode-coupling portion 310 of the can lid 300 according to one aspect of the present disclosure, the center of curvature of the curved edge may coincide with the center of the can lid 300 in the radial direction (as shown, for example, in FIG. 5).

Parts (a) and (b) of FIG. 14 illustrate shapes of the can lid 300 according to other aspects of the present disclosure. For reference, Cases 1 to 4 of FIG. 14, mentioned below, are not the same as Cases 1 to 4 of FIG. 11 or 12.

Part (a) of FIG. 14 is Case 1, in which the width of the bridge 350 (width in the direction perpendicular to the radial direction when viewed along the axial direction) is 6 mm.

Part (b) of FIG. 14 is Case 2, in which the width of the bridge 350 is 4 mm, and the radial length of the bridge 350 is the same as Case 1.

Part (c) of FIG. 14 is Case 3, in which the width of the bridge 350 is 4 mm, but the radial length of the bridge 350 is shorter than Case 2.

Part (d) of FIG. 14 is Case 4, in which the width of the bridge 350 is 5 mm, and the radial length of the bridge 350 is the same as Case 1 and Case 2.

After forcibly press-fitting the can lids 300 of Cases 1 to 4 into the openings 210 of the cell housings 200 of the same shape, a FEM analysis was performed to calculate the maximum radius and maximum gap of the cell housings 200 for each case. The FEM analysis was performed using a commercially available simulation tool, i.e., Abaqus, as noted above. For reference, for each case, the angle of the line passing longitudinally along the middle of any one bridge 350 from the center of the can lid 300 was set to 60 degrees. Based on this, 0 degrees and 120 degrees were set in the counterclockwise and clockwise directions, respectively.

As a result of the FEM analysis, in each case, after the can lid 300 was forcibly press-fit into the cell housing 200, the radius of the cell housing 200 was calculated to be symmetrical in the left and right circumferential directions with respect to the 60 degree angle. In each case, it was calculated that, the maximum radius of the cell housing 200 occurs at the point where the radial stiffness of the can lid 300 is greatest.

After the press-fitting of the can lid 300 and the cell housing 200, a FEM analysis was performed to calculate the maximum radius of the cell housing 200. The FEM analysis was performed using the commercially available simulation tool noted above, i.e., Abaqus. In Case 1, the maximum radius of the cell housing 200 was calculated as 23.1815 mm at approximately 108 degrees. In Case 2, the maximum radius of the cell housing 200 was calculated as 23.1814 mm at approximately 112 degrees. In Case 3, the maximum radius of the cell housing 200 was calculated as 23.1823 mm at approximately 120 degrees. In Case 4, the maximum radius of the cell housing 200 was calculated as 23.1814 mm at approximately 110 degrees.

Next, after the can lid 300 was press-fitted into the cell housing 200, a FEM analysis was performed to calculate the maximum value of the gap between the can lid 300 and the cell housing 200 (i.e., the radial gap between the outermost edge of the can lid 300 and the innermost edge of the cell housing 200 shown in FIG. 10). Again, the FEM analysis was performed using a commercially available simulation tool, i.e., Abaqus. The maximum value of the gap between the can lid 300 and the cell housing 200 was calculated at about 120 degrees in all of Cases 1 to 4. In Case 1, the maximum value of the gap was calculated to be 0.2536 mm. In Case 2, the maximum value of the gap was calculated to be 0.2541 mm. In Case 3, the maximum value of the gap was calculated to be 0.2531 mm. In Case 4, the maximum value of the gap was calculated to be 0.2538 mm.

Comparing the FEM analysis results of Case 3 with the remaining cases, especially comparing the FEM analysis results of Case 3 with Case 2, it may be seen that when the radial length of the bridge 350 is shorter and the area of the separated portion 360 is larger, the resulting gap is smaller. Comparing the FEM analysis results of Case 1, Case 2, and Case 4, it may be seen that when the area of the separated portion 360 remains the same, the resulting gap is smaller as the width of the bridge 350 (in the direction perpendicular to the radial direction when viewed in the axial direction) is larger.

As should be apparent from the above, design of the can lid 300 involves balancing multiple countervailing considerations in order to arrive at one or more ideal designs, but it is impossible to maximize all of such considerations, since increasing one or more of them necessarily leads to a reduction in one or more others. That is, in designing an ideal can lid 300, it is desirable to achieve high heat dissipation, low electrical resistance, high stiffness (i.e., high resistance to deformation and thus good resistance to expansion under increased internal pressure), low weight, and good weldability (between the can lid 300 and the cell housing 200). As discussed above, on the one hand, increasing the area of the electrode-coupling portions 310 beneficially improves heat dissipation and reduces electrical resistance between the electrode assembly 100 and the can lid 300. On the other hand, however, increasing the area of the electrode-coupling portions 310 and/or reducing the width of the bridges 350 detrimentally increases the size of the gap between the can lid 300 and the cell housing 200, as discussed above in connection with FIG. 10, which can lead to lower welding strength between the can lid 300 and the cell housing 200, as well as a resulting reduction in expansion performance of the battery cell 10. Through their iterative design process and experimental testing, the inventors have arrived at the designs disclosed herein by balancing various competing and conflicting considerations.

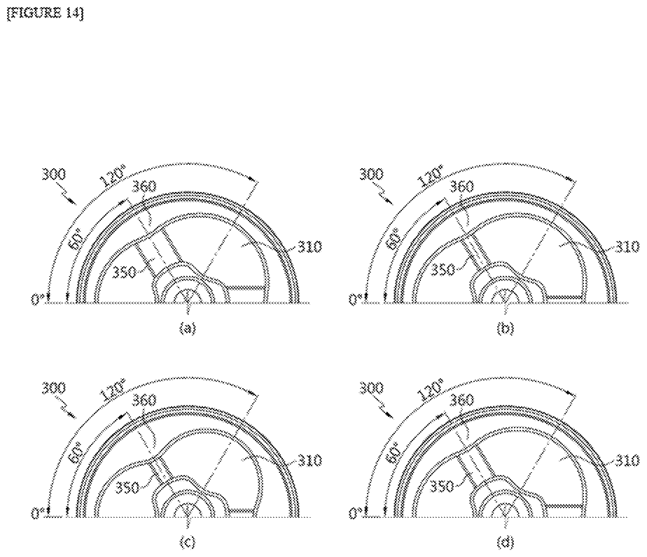

FIG. 15 is a partially cut-away perspective view of a battery pack according to an aspect of the present disclosure.

Referring to FIG. 15, a battery pack 30 according to the present disclosure may include at least one battery cell 10 according to the present disclosure. The battery pack 30 may include a pack case 20 that accommodates at least one battery cell 10.

In the drawing, for convenience of illustration, components such as one or more busbar electrical connections of the battery cells 10, a cooling unit, and an external terminal are omitted. The structure of the battery cells 10 for manufacturing the battery pack 30 has been previously described by way of examples.

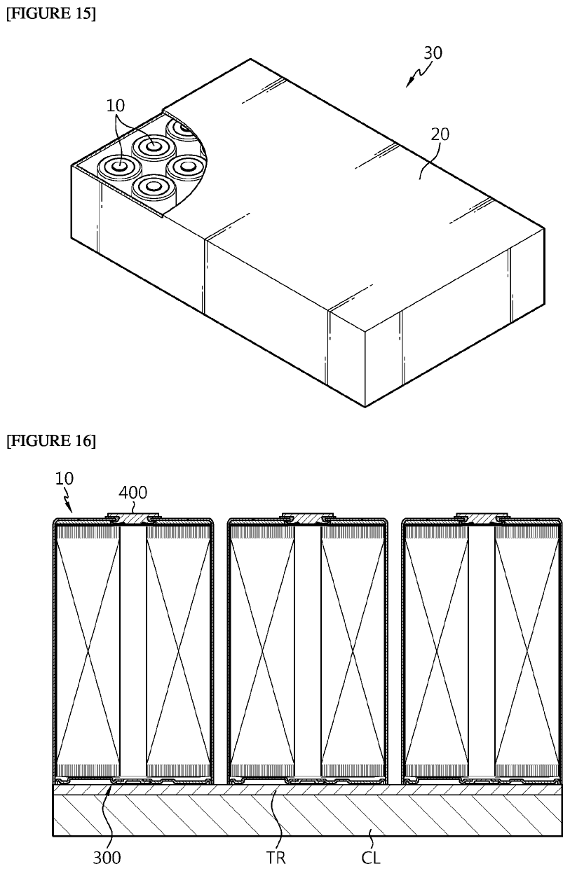

FIG. 16 is a side cross-sectional view of a battery pack according to an aspect of the present disclosure.

Referring to FIG. 16, the battery pack according to the present disclosure may further include a cooling member CL. The cooling member CL may be configured to cool the battery cell 10. The cooling member CL may be arranged at one side of the battery cell 10. The cooling member CL may be arranged on the can lid 300 of the battery cell 10. The can lid 300 may form the bottom of the battery cell 10. As a result, the battery pack may be configured with a bottom cooling structure.

A heat transfer member TR may be arranged between the battery cell 10 of the battery pack and the cooling member CL. The heat transfer member TR has relatively high thermal conductivity and may be configured to facilitate heat transfer between the battery cell 10 and the cooling member CL. The heat transfer member TR may be in contact with the can lid 300. The heat transfer member TR may be in contact with the cooling member CL.

The heat transfer member TR may include known thermal interface materials (TIMs). For example, the heat transfer member TR may include at least one of thermal grease, thermal glue, and thermal resin. The heat transfer member TR may further include at least one of a PET (polyethylene terephthalate) sheet.

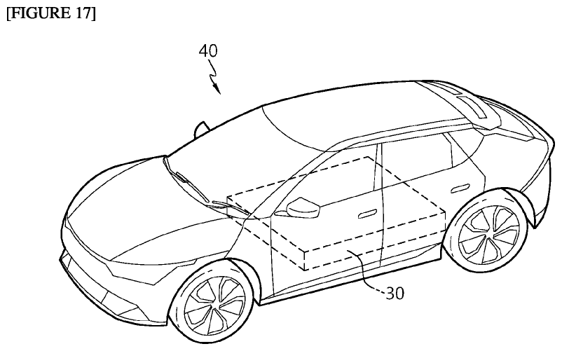

FIG. 17 is a perspective diagrammatic illustration of a vehicle including the battery pack of FIG. 15 according to an aspect of the present disclosure.

Referring to FIG. 17, the battery pack 30 according to an aspect of the present disclosure may be incorporated into a vehicle 40, such as an electric vehicle or a hybrid electric vehicle. That is, the vehicle 40 according to the present disclosure may include the battery pack 30 according to the present disclosure. The battery pack 30 may be installed in the body frame under the vehicle seat or in the trunk space. In addition to the battery pack 30, the vehicle 40 according to the present disclosure may further include various other components included in the vehicle 40. For example, the vehicle 40 according to an aspect of the present disclosure, in addition to the battery pack 30 according to the present disclosure, may further include a vehicle body, a motor, a control device such as an ECU (electronic control unit), and the like.

In addition, it should be understood that the battery pack 30 according to the present disclosure may be installed in other devices, apparatus, and equipment, such as energy storage systems utilizing secondary batteries.

Although terms indicating directions such as up(ward) and down(ward) are used in this specification, it is to be understood to those skilled in the art to which the present disclosure pertains that these terms are only for convenience of explanation with reference the relevant drawings and may vary depending on the position of the target object or the position of the observer.

As described above, although the present disclosure has been described with reference to limited aspects and drawings, the present disclosure is not limited thereto, and various modifications and variations are possible without departing from the technical idea of the present disclosure and the scope of equivalence of the claims provided below, as would be understood by those skilled in the art to which the present disclosure pertains. Therefore, the foregoing aspects should be considered in a descriptive sense rather than a limiting sense. Accordingly, the true scope of the present disclosure is defined by the claims, and all variations falling within the equivalents thereof should be construed as being included in the present disclosure.

### REFERENCE SYMBOLS

10: battery cell
20: pack case
30: battery pack
40: vehicle
100: electrode assembly
112a: first uncoated portion
112b: second uncoated portion
200: cell housing
210: opening
220: closed portion
230: vent notch portion
300: can lid
310: electrode-coupling portion
311: extension
320: flat portion
321: bent portion
330: plug
331: protrusion
332: expansion portion
340: plug-coupling portion
341: insert portion
342: mounting portion
350: bridge
360: separated portion
370: edge portion
371: convex portion
372: outer wall
400: electrode terminal
500: insulating gasket
600: current collector
700: insulator
C: winding center core
A: central axis
H: injection port
ID: indicator portion
R1: first round portion
R2: second round portion
SW: wall portion
CW: corner wall portion
CL: cooling member
TR: heat transfer member

What is claimed is:

1. A battery cell comprising:
an electrode assembly in which a plurality of electrodes having a separator interposed therebetween are wound around a central axis;
a cell housing having an open end and a closed end that oppose one another along an axial direction parallel to the central axis, the open end defining an opening into an interior space within the cell housing, the interior space accommodating the electrode assembly therein; and
a can lid coupled to the open end of the cell housing so as to cover the opening, the can lid having a plurality of electrode-coupling portions electrically connected to one of the electrodes of the electrode assembly,
wherein an area defined by the plurality of electrode-coupling portions in a transverse plane extending orthogonally to the central axis occupies from 25% to 50% of a total area of the can lid within the transverse plane.

2. The battery cell according to claim 1,
wherein each of the plurality of electrode-coupling portions is shaped such that a width of the respective electrode-coupling portion increases at progressively larger distances from the central axis along a radial direction, where the width of the respective electrode-coupling portion is defined along a direction perpendicular to the radial direction.

3. The battery cell according to claim 1,
wherein the plurality of the electrode-coupling portions are arranged rotationally-symmetrically about the central axis.

4. The battery cell according to claim 1,
wherein the can lid further includes:
an injection port positioned along the central axis and configured to open into the interior space of the cell housing.

5. The battery cell according to claim 4,
wherein a flat portion surrounds the injection port, the flat portion being spaced further from the electrode assembly along the axial direction than the plurality of electrode-coupling portions, and wherein a common boundary defined between the flat portion and at least one of the electrode-coupling portions is recessed towards the central axis.

6. The battery cell according to claim 1,
wherein the can lid includes at least one separated portion extending radially inwardly towards the central axis along a radial direction from a region along an outer perimeter of the can lid so as to at least partially partition two neighboring electrode-coupling portions in a circumferential direction about the central axis, the at least one separated portion being axially spaced further from the electrode assembly along the axial direction than the plurality of electrode-coupling portions.

7. The battery cell according to claim 6,
wherein the separated portion is axially spaced further from the electrode assembly than the plurality of electrode-coupling portions by a distance in a range from 0.6 mm to 1.3 mm.

8. The battery cell according to claim 6,
wherein a width of the separated portion in the circumferential direction is in a range from 6.59% to 44.0% of a length of a diameter of the can lid.

9. The battery cell according to claim 6,
wherein the can lid includes at least one bridge elongated along the radial direction and extending radially inwardly towards the central axis from the at least one separated portion so as to at least partially partition the two neighboring electrode-coupling portions in the circumferential direction, the at least one bridge being axially spaced further from the electrode assembly than the plurality of electrode-coupling portions.

10. The battery cell according to claim 9,
wherein a width of the at least one bridge in a direction perpendicular to the radial direction is in a range from 4.40% to 22.0% of a length of a diameter of the can lid.

11. The battery cell according to claim 9,
wherein the at least one bridge is axially spaced further from the electrode assembly than the plurality of electrode-coupling portions, and wherein the separated portion is axially spaced further from the electrode assembly than the at least one bridge.

12. The battery cell according to claim 11,
wherein the at least one bridge is axially spaced further from the electrode assembly than the plurality of electrode-coupling portions by a distance in a range from 0.3 mm to 1.0 mm.

13. The battery cell according to claim 11,
wherein the separated portion is axially spaced further from the electrode assembly than the at least one bridge by a distance in a range from 0.2 mm to 0.3 mm.

14. The battery cell according to claim 1,
wherein the can lid includes an indicator portion that displays product information about the battery cell, the indicator portion being positioned on a region of the can lid other than along the plurality of electrode-coupling portions.

15. The battery cell according to claim 1,
wherein the can lid includes:
a wall portion extending along the axial direction away from the electrode assembly from at least a part of an edge of a first one of the plurality of electrode-coupling portions; and
a first round portion defined along an outer boundary of the can lid at a junction between the wall portion and the first electrode-coupling portion, the first round portion having a rounded shape,
wherein a radius of curvature of the first round portion is in a range of 0.05 mm to 0.30 mm.

16. The battery cell according to claim 1,
wherein the can lid includes:
a first wall portion extending along the axial direction away from the electrode assembly from a radially outer edge of a first one of the plurality of electrode-coupling portions;
a second wall portion extending along the axial direction away from the electrode assembly from an edge of the first electrode-coupling portion that is oriented along a radial direction towards the central axis; and
a second round portion defined along an outer boundary of the can lid adjoining the first electrode-coupling portion, the second round portion extending along a curved path between the first wall portion and the second wall portion,
wherein a radius of curvature of the curved path of the second round portion at an axial position of the first electrode-coupling portion is in a range of 1.0 mm to 5.0 mm.

17. The battery cell according to claim 16,
wherein the radius of curvature of the curved path of the second round portion increases as an axial distance from the electrode assembly increases.

18. The battery cell according to claim 1,
wherein the can lid does not include a venting structure configured to rupture under internal gas pressure within the interior space so as to vent gas from the interior space.

19. The battery cell according to claim 18,
wherein the closed end of the cell housing has a venting structure in the form of a notch formed along at least a portion of a surface of the closed end.

20. The battery cell according to claim 1,
wherein each of the electrode-coupling portions has a curved edge defining a boundary of the respective electrode-coupling portion furthest from the central axis, wherein each curved edge has a center of curvature positioned along a respective radial direction between the central axis and the respective curved edge.

21. A battery pack comprising at least one battery cell according to claim 1.

22. The battery pack according to claim 21, further comprising:
a cooling member arranged along the can lid of each of the at least one battery cell.

23. A vehicle comprising at least one battery pack according to claim 21.
